(19) United States
(12) Patent Application Publication
(10) Pub. No.: US 2023/0406770 A1
(43) Pub. Date: Dec. 21, 2023

(54) COMPOSITIONS CONTAINING AMINO ACIDS AS AN ADMIXTURE FOR CEMENT-BASED MATERIALS

(71) Applicants: Board of Regents, The University Of Texas System, Austin, TX (US); The University of Maine System Board of Trustees, Orono, ME (US)

(72) Inventors: Warda Ashraf, Arlington, TX (US); Rakibul I. Khan, Orono, ME (US); Muhammad Intesarul Haque, Arlington, TX (US)

(21) Appl. No.: 18/335,922

(22) Filed: Jun. 15, 2023

Related U.S. Application Data
(60) Provisional application No. 63/352,354, filed on Jun. 15, 2022.

(51) Int. Cl. C04B 24/12; C04B 28/18; C04B 28/08; C04B 40/02

(52) U.S. Cl. CPC C04B 24/123; C04B 28/188; C04B 28/08; C04B 40/0231

(57) ABSTRACT

Amino acid-containing carbonated composites of silicate-containing cementitious materials and methods of making the same, are disclosed. The carbonated composites contain polymorphs of CaCO3, that are controlled in terms of type (i.e., relative proportion) and size when compared to the same composites formed without amino acids and show improved mechanical properties. Methods of making carbonated silicate-containing cementitious materials with improved properties include supplementing a silicate-containing cementitious material with one or more amino acids prior to carbonation, in effective amounts to confer to the resulting carbonated composite material has one of the following properties when compared to composite materials cured under the same conditions in the absence of the one or more amino acids.

### CROSS REFERENCE TO RELATED APPLICATIONS

This application claims benefit of U.S. Provisional Application No. 63/352,354, filed Jun. 15, 2022, which is specifically incorporated by reference herein in its entirety.

### STATEMENT REGARDING FEDERALLY FUNDED RESEARCH

This invention was made with government support under 2028462 and 1542205 awarded by National Science Foundation. The government has certain rights in the invention.

### FIELD OF THE INVENTION

This invention is generally in the field of compositions and methods for increasing strength of composites made from cement-based materials.

### BACKGROUND OF THE INVENTION

Concrete or cement-based composites are responsible for up to 9% of global man-made CO₂ emissions. Production of ordinary Portland cement (OPC) is also one of the most energy-intensive manufacturing processes The conventional cement industry is responsible for 5-8% of global CO2 emissions to the environment. Utilization of alternative cementitious materials instead of OPC may allow mankind to achieve a lower CO₂ footprint from concrete and other cement-based composites. Carbonation-activated (or CO₂-cured) calcium silicate is one such alternative cementitious material. The hardening process of this type of cementitious material involves the reaction of calcium silicates with CO₂ in the presence of moisture (addressed as ‘carbonation or CO₂ curing’). The carbonation reaction products of calcium silicates are CaCO₃ and Ca modified silica gel (Ca/Si atomic ratio˜0.4), which act as the binding phases and provide strength to the hardened matrix. This hardened matrix will be referred to as ‘carbonated cement composite’ for the remainder of this disclosure. During the carbonation reaction, these composites can also store up to 18% (by wt.) of CO2 and therefore, presents an attractive opportunity for CO₂ sequestration as well.

Previous studies have shown that the mechanical performances of these carbonated cement composites are significantly influenced by the crystalline properties of CaCO3. In the case of calcium silicate-containing cementitious materials, the primary polymorphs of CaCO3 formed during the carbonation include calcite, aragonite, vaterite, and amorphous calcium carbonate (ACC). Formation of these polymorphs of CaCO3 ideally should follow the Ostwald's process; that is, the least stable polymorph ACC is the first to nucleate, which then crystallizes to form vaterite or aragonite (also metastable), and finally, forms calcite— the most stable polymorph. Nevertheless, this conversion route of CaCO3 polymorphs in carbonated cement composites is affected by several factors including relative humidity, CO2 concentration, pH, silica content, and magnesium content. Because of these factors, it is difficult to control the relative proportions of the different CaCO3 polymorphs formed in the carbonated composites. Further, the intrinsic properties of these CaCO3 polymorphs are significantly different. As an example, the stiffness of vaterite, aragonite, and calcite are 39.13 GPa, 67 GPa, and 72.83 GPa, respectively (data not available for ACC). The variation in the relative proportions of different CaCO3 polymorphs along with their various intrinsic characteristics often results in significant variability in the mechanical performance of carbonated cement composites. Previous studies have shown that 20 to 40% variation in the mechanical performances (i.e., strength and Young's modulus) of the carbonated composites produced in a similar carbonation setup can be observed due to the presence of different polymorphs of CaCO3. Developing the ability to control the CaCO3 polymorph formation and stabilization in carbonated cement composites will enable microstructure-based design optimization of this sustainable cementitious system.

It is an object of the present invention to provide methods for controlling the CaCO₃ polymorph formation and stabilization in carbonated cement composites.

It is also an object of the present invention to provide carbonated cement composites with improved stability in the CaCO₃ polymorphs, and improved strength.

It is also an object of the present invention to provide supplemented cement materials for use in producing carbonated cement composites with improved stability in the CaCO₃ polymorphs, and improved strength.

### SUMMARY OF THE INVENTION

Amino acid supplemented binder compositions are provided. In one embodiment, the compositions are provided in solid form, such as a powder. The amino acids are preferably naturally occurring amino acids, and more preferably, hydrophilic amino acids. The amino acids are preferably include L-naturally occurring amino acids preferably positively charged amino acids, negatively charged amino acids, for example, and polar (but not charged) amino acids. In particularly preferred embodiments, the amino acid is selected from Arginine, aspartate and serine. The binder material is supplemented with amino acids in effective amounts to increase one or more properties of resulting composites made therefrom, as set forth below, when formulated into a composite.

Amino acid-containing carbonated composites of silicate-containing cementitious materials and methods of making the same, are disclosed. The disclosed carbonated composites contain polymorphs of CaCO₃, that are controlled in terms of type (i.e., relative proportion) and size when compared to the same composites formed without amino acids.

The amino acids are added to the calcium silicate mineral materials composition, in an effective amount to confer one or more of the following properties to the resulting composite: (a) reduction in the amount of calcite and fully polymerized silica gel, (b) increase in the proportions of mCaCO3 (metastable ACC, aragonite, and vaterite polymorphs), (c) reduction in the amounts of CaCO3 (% by wt of the carbonated sample) compared to the control batch after the same carbonation duration (d) increase in the amounts of unreacted calcium silicate mineral, (e) refined pore sizes (based on critical pore diameter), and (e) increase in the compressive and flexural strengths in carbonation-activated calcium silicate composite materials formed following incorporation of the amino acid in the calcium silicate material composition, when compared to carbonation-activated composites formed without amino acids. Examples of composite materials include any end product that results from the mixing of cement material with water/liquids, including, but not limited to bridge girders, beams, blocks, hardscape components such as pavers, edging blocks, stepping stones, etc.

A method of making carbonated composites of silicate-containing cementitious materials is provided. The method includes supplementing a silicate-containing cementitious material with one or more amino acids prior to carbonation, in effective amounts to confer to the resulting carbonated composite material has one of the following properties when compared to composite materials cured under the same conditions in the absence of the one or more amino acids: (a) reduced amount of calcite and fully polymerized silica gel, (b) increase in the proportions of mCaCO₃ (metastable ACC, aragonite, and vaterite polymorphs), (c) reduced amounts of CaCO₃ (% by wt of the carbonated sample) compared to the control batch after the same carbonation duration (d) increase in the amounts of unreacted calcium silicate mineral, (e) refined pore sizes (based on critical pore diameter), and (e) improved mechanical properties such as increase in the compressive and flexural strengths, increased mean modulus in/of carbonation-activated calcium silicate composite materials formed following incorporation of the amino acid in the calcium silicate material composition, when compared to carbonation-activated composites formed without amino acids. The amino acid is preferably provided as a solution to a solid form of the silicate-containing cementitious material at a solution to solid ratio of about 0.42.

### BRIEF DESCRIPTION OF THE DRAWINGS

FIG. 1 is a schematic illustrating the steps of collecting the mercury intrusion porosimeter (MIP) sample.

FIGS. 2A-2B are FTIR spectra of carbonated wollastonite FTIR spectra of carbonated wollastonite: without any amino acid (FIG. 2A), with 0.25 M of L-arginine (FIG. 2B), with 0.25 M of L-serine (FIG. 2C), and with 0.25 M of L-aspartic acid (normalized with respect to maximum peak height, FIG. 2D).

FIG. 3A is a graph showing the comparison of the FTIR spectra of carbonated wollastonite with and without amino acids after 145 hours of carbonation. The FTIR spectra of the two years old samples are shown in FIG. 3B.

FIG. 4 is a graph showing the X-ray diffraction patterns showing the effects of amino acids on the polymorphs of CaCO3 after 145 hours of carbonation.

FIG. 5 is a bar graph showing quantitative phase proportions in the 145-hours CO₂ cured composites.

FIGS. 6A-6D are SEM images (4000×) showing microstructure of carbonated composites (FIG. 6A) without any amino acid, (FIG. 6B) with 0.25 M L-arginine, (FIG. 6C) with 0.25 M L-aspartic acid, and (FIG. 6D) with 0.25 M L-serine acid. The scale bar represents a distance of 2 μm.

FIGS. 7A-7D are SEM images showing different locations of the carbonated composite containing 0.25 M L-serine. The scale bar presents 2 μm.

FIGS. 8A-8D are TGA-MS plots showing the releases of H₂O and CO₂ gases from carbonated wollastonite matrixes: control batch (FIG. 8A), L-arginine (FIG. 8B), L-serine (FIG. 8C) and L-aspartic acid containing batches (FIG. 8D).

FIG. 9A shows TGA plots of carbonated wollastonite composites with and without amino acids. FIG. 9B is a sample TGA graph showing the relative weight loss due to the mCaCO₃ and total CaCO₃ in the composite. FIG. 9C is a line graph showing the relative proportions of mCaCO₃ with carbonation duration (hours). FIG. 9D is a line graph showing the total CaCO₃ (% by weight) content in the carbonated matrices with carbonation duration.

FIG. 10 is a line graph showing the effects of amino acids on the pore size distribution of the carbonated composites.

FIGS. 11A and 11B are bar graphs showing the effects of amino acids on the compressive strengths (FIG. 11A) and flexural strengths of the carbonated composites after 300 hours of carbonation (FIG. 11B). Error bars represent one standard deviation. FIG. 11C is a schematic of the proposed mechanism of in-situ nanocomposite formation in carbonated wollastonite composites.

FIGS. 12A and 12B show particle size distribution, and FIG. 12C SEM images of wollastonite (CaSiO3). The scale bar shows a 2 μm distance.

FIG. 13A shows CaCO3 content (% by weight) vs ln(t), (FIG. 13B and FIG. 13C) representing the predicated model (lines) and actual (data points) values of ln[1−(1−α)1/3] vs ln(t) for carbonation kinetics of various amino acid batches, (FIG. 13B) 0.13 M, and (FIG. 13C) 0.25 M concentration. Dashed lines represent stage-1 and solid lines represent stage-2 carbonation reaction, respectively.

FIG. 14 shows Carbonation reaction rate constants of ‘stage 1’.

FIGS. 15A-15D show SEM images showing the microstructure of carbonated wollastonite composites (FIG. 15A) control, (FIG. 15B) with 0.25 M L-Arg, (FIG. 15C) with 0.25 M L-Ser, and (FIG. 15D) with 0.25 M L-Asp. The scale bar shows a 2 μm distance (C: calcite, CS: wollastonite, V: vaterite, ACC: amorphous CaCO3).

FIGS. 16A-16D show frequency distribution plot of elastic modulus for (FIG. 16A) control, (FIG. 16B) L-Arg, (FIG. 16C) L-Ser and (FIG. 16D) L-Asp paste samples.

FIGS. 17A-17C show ionic concentration of (FIG. 17A) Ca2+, (FIG. 17B) Si2+, and (FIG. 17C) pH of the solutions with soaking durations.

FIGS. 18A-18C show thermogravimetric analysis (TGA) of carbonated composites after moisture exposure: (FIG. 18A) relative proportions of metastable CaCO3 with soaking duration, (FIG. 18B) CaCO3 content (%) by weight of carbonated matrix with soaking duration, (FIG. 18C) Thermogravimetric plots of paste samples of 48 h soaking.

FIGS. 19A-19D show FTIR normalized plots of carbonation cured wollastonite: (FIG. 19A) control, (FIG. 19B) with L-Arg, (FIG. 19C) with L-Ser, and (FIG. 19D) with L-Asp acid. 0 h indicates the FTIR spectra of wollastonite sample carbonated for 145 h. 6 h, 14 h, and 48 h represent the moisture exposure durations of the carbonated wollastonite composites.

FIGS. 20A-20B show (FIG. 20A) critical crack length, and (FIG. 20B) Fracture energy of carbonated wollastonite composites with amino acids (0.25 M).

FIG. 21A-21B show load with crack mouth opening displacement (CMOD) plot, (FIG. 21A) without amino acid, and (FIG. 21B) L-Aspartic acid (0.25 M) containing wollastonite.

FIG. 22 shows particle size distribution of the synthesized γ-C2S.

FIG. 23 is a schematic diagram of the sample preparation

FIGS. 24A-24C show thermogravimetric analysis of 7 days carbonated g-C₂S paste samples; (FIG. 24A) 2.5% batches, (FIG. 24B) 5% batches, (FIG. 23C) comparison of CaCO₃ contents formation among the batches FIGS. 25A and 25B show Compressive strength (FIG. 25A) and flexural strength (FIG. 25B) (after 7 days of carbonation period)

FIGS. 26A-25B shows molecular structure of (FIG. 26A) L-aspartic acid, (FIG. 26B) L-glutamic acid

### DETAILED DESCRIPTION OF THE INVENTION

The disclosed compositions and methods are based on a discoveries following hypothesis that amino acids can enhance the performance of cement based composites by altering the polymorphs of CaCO3. The experimental findings presented herein were designed to verify the above-stated hypothesis. Based on the experimental tasks, this data in this application answered two questions: (i) is it possible to stabilize the mCaCO3 phases in carbonated cement composites by mimicking the biomineralization process? (ii) how such formation of mCaCO3 polymorphs affects the strength and microstructure of the carbonated cement composites?

### I. Definitions

“Carbonation or CO₂ curing as used herein refers to hardening process of this type of cementitious materials such as calcium silicate mineral material involving the reaction of calcium silicates with CO₂ in the presence of moisture.

“Flexural strength” as used herein refers to the stress in a material just before it yields in a flexure test.

### II. Compositions

The disclosed compositions include binders, preferably, carbonation-activated (or CO₂ cured) calcium silicate mineral materials supplemented with amino acids.

A cement is a binder, a substance used for construction that sets, hardens, and adheres to other materials to bind them together. Cement is seldom used on its own, but rather to bind sand and gravel (aggregate) together. Cement mixed with fine aggregate produces mortar for masonry, or with sand and gravel, produces concrete. Binders are substances which are used to bind inorganic and organic particles and fibers to form strong, hard and/or flexible components. This is generally due to chemical reactions which take place when the binder is heated, mixed with water and/or other materials, or just exposed to air. Cementing materials that are widely used for construction are materials that exhibit characteristic properties of setting and hardening when mixed to a paste with water. There are four main groups of binders: mineral binders, bituminous binders, natural binders and synthetic binders. Cements used in construction are usually inorganic, often lime or calcium silicate based, which can be characterized as non-hydraulic or hydraulic respectively, depending on the ability of the cement to set in the presence of water

Mineral Binders can be divided into three categories: hydraulic binders, which require water to harden and develop strength; non-hydraulic binders, which can only harden in the presence of air; thermoplastic binders, which harden on cooling and become soft when heated.

A. Binder Materials

The disclosed compositions and methods use non-hydraulic binder materials (for example, wollastonite, γ-C₂S), semi-hydraulic (for example, slag, Belite cement) binders, and a hydraulic (OPC) binders (with very low doses of amino acids). In a preferred embodiment, the binder is a non-hydraulic or semi hydraulic binder.

In one embodiment, the non-hydraulic binder is a calcium silicate mineral material. Tricalcium silicate (C3S), β-dicalcium silicate (β-C2S), γ-dicalcium silicate (γ-C₂S), tricalcium disilicate (C3S2) and monocalcium silicate (CS) can react with CO₂ and form strong monolithic matrices. Wollastonite is naturally occurring low-lime calcium silicate (CaO·SiO₂) mineral with a substantially lower carbon footprint compared to the ordinary Portland cement (OPC). Thus, in a preferred embodiment, the binder material is calcium silicate mineral containing material such as wollastonite, β-C2S, γ-C2S, etc. Wollastonite is a group of innosilicate mineral, with a formula, CaSiO3 that may include small amount of magnesium, manganese and iron substituting for calcium. A valuable industrial mineral, wollastonite is white, gray, or pale green in color. It occurs as rare, tabular crystals or massive, coarse-bladed, foliated, or fibrous masses. Its crystals are usually triclinic, although its structure has seven variants, one of which is monoclinic. These variations are however, indistinguishable in hand specimens. Wollastonite forms as a result of the contact metamorphism of limestones and in igneous rocks that are contaminated by carbon-rich inclusions. It can be accompanied by other calcium containing silicates, such as diopside, tremolite, epidote, and grossular garnet. Wollastonite also appears in regionally metamorphosed rocks in schists, slates, and phyllites. It forms when impure limestone or dolomite is subjected to high temperature and pressure, which sometimes occurs in the presence of silica-bearing fluids as in skarns or in contact with metamorphic rocks.

In another embodiment, the binder material is a semi-hydraulic material such as slag or belite cement. Ground granulated blast furnace slag (hereby referred as slag) have attracted attention due its latent hydraulic properties, its widespread availability and the observation that slag based cement composites have shown superior durability as represented by good resistance against chemical attacks, including chloride penetration.

B. Amino Acids

Amino acids that are useful in the disclosed methods and compositions may be a standard or canonical amino acid or a non-standard amino acids. As used herein, “standard amino acid” and “canonical amino acid” refer to the twenty amino acids that are encoded directly by the codons of the universal genetic code denominated by either a three letter or a single letter code as indicated as follows: Alanine (Ala, A), Arginine (Arg, R), Asparagine (Asn, N), Aspartic Acid (Asp, D), Cysteine (Cys, C), Glutamine (Gln, Q), Glutamic Acid (Glu, E), Glycine (Gly, G), Histidine (His, H), Isoleucine (Ile, I), Leucine (Leu, L), Lysine (Lys, K), Methionine (Met, M), Phenylalanine (Phe, F), Proline (Pro, P), Serine (Ser, S), Threonine (Thr, T), Tryptophan (Trp, W), Tyrosine (Tyr, Y), and Valine (Val, V). Useful amino acids are preferably, naturally occurring amino acids and are preferably hydrophillic, however, unless otherwise limited, may encompass known analogs of natural amino acids that can function in a similar manner as naturally occurring amino acids. Amino acids useful for formation of the disclosed composite materials preferably include L-naturally occurring amino acids, for example, positively charged amino acids, for example, L-arginine (L-Arg) and L-lysine (L-Lys), negatively charged amino acids, for example, L-aspartic (L-Asp) and L-glutamate (L-glu) and polar (but not charged) amino acids, for example, L-serine (L-Ser), threonine (Thr), cysteine (Cys), asparagine (Asn), glutamine (Gln), and tyrosine (Tyr). In one preferred embodiment, the amino acid is a positively charged amino acids, preferably, L-arginine. A non-limiting list of non-standard amino acids can be found in Table 1.

TABLE 1
List of nonstandard amino acids

| Name | NAA Name | IUPAC Name | CAS Number |
|---|---|---|---|
| CbzK | N⁻-- | (S)-2-Amino-6- | 1155-64-2 |
| | Carbobenzoxy- | (phenylmethoxycarbonyl- | |
| | L-lysine | amino)hexanoic acid | |
| mK | N⁻--Methyl-L- | (S)-2-Amino-6- | 7622-29-9 |
| | lysine | (methylamino)hexanoic | |
| | hydrochloride | acid hydrochloride | |
| 2mK | N⁻-,N⁻--Dimethyl- | (S)-2-Amino-6- | 2259-86-1 |
| | L-lysine | (dimethylamino)hexanoic | |
| | hydrochloride | acid hydrochloride | |
| 3mK | N⁻-,N^{⊐},N⁻-- | (S)-2-Amino-6- | 55528-53-5 |
| | Trimethyl-L- | (trimethylamino)hexanoic | |
| | lysine chloride | acid chloride | |
| AcK | N⁻--Acetyl-L- | (S)-2-Amino-6- | 692-04-6 |
| | lysine | (acetylamino)hexanoic | |
| | | acid | |
| NicoK | N⁻--Nicotinyl-L- | (S)-2-Amino-6- | 158276-23-4 |
| | lysine | (nicotinylamino)hexanoic | |
| | | acid | |
| AlocK | N⁻-- | (S)-2-Amino-6- | 6298-03-9 |
| | Allyloxycarbonyl- | (allyloxycarbonyl | |
| | L-lysine | amino)hexanoic acid | |
| Control | — | — | — |
| 2BrF | L-2-Bromo | (S)-2-amino-3-(2- | 42538-40-9 |
| | phenylalanine | bromophenyl)propanoic | |
| | | acid | |
| 2IF | L-2-Iodo | (S)-2-amino-3-(2- | 167817-55-2 |
| | phenylalanine | iodophenyl)propanoic acid | |
| 2MeF | L-2-Methyl | (S)-2-amino-3-(2- | 80126-53-0 |
| | phenylalanine | methylphenyl)propanoic | |
| | | acid | |

Amino acids reduce the carbonation reaction, so the amino acids are added at amounts that are effective to provide the listed benefits (below) without producing deleterious effects. For example, amino acid doses that are too high can completely stop the reaction and decrease the mechanical performance. Further, amount of amino acids that are too high also decreases the workability of this system. Thus, amino acids should be used at a concentration ranging from about 1-20%, for example, 3, 4, 5, 6, 7, 8, 9, 10, 11, 12, 13, 14, 15, 16, 17, 18, 19 or 20%, preferably from about 5˜8% (wt. of binder, for example, wollastonite) amino acids addition improved performance. For example, for 8%, in 100 g of wollastonite, up to 8 g of amino acids is used. Concentrations of amino acid outside the range of about 3-20% can be used, so long as the selected amino acid is effective to provide the beneficial properties listed below, without reducing and even stopping the carbonation reaction.

In another preferred embodiment, the amino acid is negatively charged amino acids, preferably, L-aspartic (L-Asp), used at a concentration ranging from about 3-20%, for example, 3, 4, 5, 6, 7, 8, 9, 10, 11, 12, 13, 14, 15, 16, 17, 18, 19 or 20%, preferably from about 5˜8%. In still another preferred embodiment, the amino acid and polar (but not charged) amino acids, preferably L-serine, used at a concentration ranging from about 3-20%, for example, 3, 4, 6, 7, 8, 9, 10, 11, 12, 13, 14, 15, 16, 17, 18, 19 or 20%, preferably from about

In some embodiments, the amino acid is added to the binder composition as solid, to provide a solid supplemented binder composition. In other embodiments, the amino acid is preferably added to a solid calcium silicate mineral material as a solution, for example, at a solution to solid ratio by weight of 0.1 to about 1, preferably, from about 0.2 to about 0.5, for example, 0.3, 0.4, 0.42, 0.43, 0.44, etc., preferably of about 0.42.

The amino acids are added to the binder materials composition, in an effective amount to confer one or more of the following properties to composite materials made therefrom, following a carbonation process: (a) significantly reduce the amount of calcite and fully polymerized silica gel, (b) increase the proportions of mCaCO₃ (metastable ACC, aragonite, and vaterite polymorphs), (c) reduce the amounts of CaCO₃ (% by wt of the carbonated sample) compared to the control batch after the same carbonation duration (d) increase the amounts of unreacted calcium silicate mineral, (e) refine pore sizes (based on critical pore diameter), (f) increase compressive and flexural strengths in carbonation-activated calcium silicate composite materials formed following incorporation of the amino acid in the calcium silicate material composition, when compared to carbonation-activated composites formed without amino acids; (g) improve fracture properties such as fracture energy, and (h) increase mean moduli of the supplemented binder material. The studies herein demonstrate that amino acids, used as disclosed herein, result in the stabilization of typical mCaCO3, namely ACC, vaterite, and aragonite, in carbonated binder composites. The formation and stabilization of mCaCO3 results in a lower degree of carbonation of wollastonite under similar experimental conditions. The total porosity of the carbonated composite is increased due to the addition of amino acids. However, amino acids decrease the critical pore diameter compared to the control batch. Carbonated composites containing amino acids show up to 48% and 106% increase in compressive and flexural strengths, respectively, compared to the control batch. Thus carbonated composites containing amino acids show at least 40, 45, and up to 50% increase in compressive and at least 70, 810, 90, 100, 105 or 110% in flexural strengths. The carbonation rate decreases with amino acid addition in the carbonated binder matrix. Moreover, the higher dosage of amino acids resulted in a slower carbonation rate. Metastable forms of CaCO3 are obtained with the addition of amino acids. The mean moduli of the carbonated composite containing the disclosed amino acids (in effective amounts) are higher than the control batch. Amino acids increased the pH of the carbonated matrix. Therefore, adding selected amino acids can be useful in stabilizing the passivation layer on the reinforcements present in carbonated concrete, thus making these reinforcements less vulnerable to corrosion.

Amino acid-containing carbonated calcium silicate has at least 120, 130, 140, 150 and 156% higher fracture energy than the control batch.

C. Carbonation-Activated Composite Materials

The disclosed calcium silicate-containing cementitious composite materials contain polymorphs of CaCO₃, that are controlled in terms of type (i.e., relative proportion) and size. In calcium silicate-containing cementitious materials, the primary polymorphs of CaCO₃ formed during the carbonation include calcite, aragonite, vaterite, and amorphous calcium carbonate (ACC). Examples of end products that can be made from the disclosed amino acid supplemented binders and cured as disclosed herein, include, but not limited to bridge girders, beams, blocks, hardscape components such as pavers, edging blocks, stepping stones, etc.

The disclosed composite materials formed in the presence of amino acids contain the one or more amino acids used to supplement the binder material used to form the composite and: (a) a significantly reduced amount of calcite and fully polymerized silica gel, (b) increased proportions of mCaCO₃ (metastable ACC, aragonite, and vaterite polymorphs), (c) reduced amounts of CaCO₃ (% by wt of the carbonated sample) compared to the control batch after the same carbonation duration (d) increased amounts of unreacted calcium silicate mineral, (e) refined pore sizes (based on critical pore diameter), and (e) increase in compressive and flexural strengths, when compared to composites formed without amino acids. A compressive strength test is used to measure the compressive strength of the resulting composite i.e., a mechanical test measuring the maximum amount of compressive load a material can bear before fracturing. The test piece, usually in the form of a cube, prism, or cylinder, is compressed between the platens of a compression-testing machine by a gradually applied load. CS=F÷ A, where CS is the compressive strength, F is the force or load at point of failure and A is the initial cross-sectional surface area. The addition of amino acids as disclosed herein reduces the amounts of calcite formation and stabilizes the typically metastable CaCO3 polymorphs, including ACC, vaterite, and aragonite, in carbonated composites. In the experiments disclosed herein, wollastonite samples were kept at 50° C. before testing. In one embodiment, the amino acid-containing composites have a CaCO3 content less than 30%, preferably less than 25% by weight of the carbonated matrix, following up to 25 hours of carbonation. The pore size distributions of the carbonated composites, as determined using the Mercury Intrusion Porosimeter (MIP), shows a reduced critical pore size (size of the pore with maximum volume) of the matrix, when compared to control composites (i.e., cured without amino acids). Thus the disclosed composites can, in some embodiments, contain critical pore diameters of about 1.07 μm and 0.86 Data in the present application shows that amino acid supplementation of binder as disclosed herein results in reduced the critical porosity (i.e., instead of a large pore, it creates small pores) in products (composites made therefrom). The carbonated composites containing amino acids showed up to 48% and 106% increase in compressive and flexural strengths, respectively, compared to the control batch

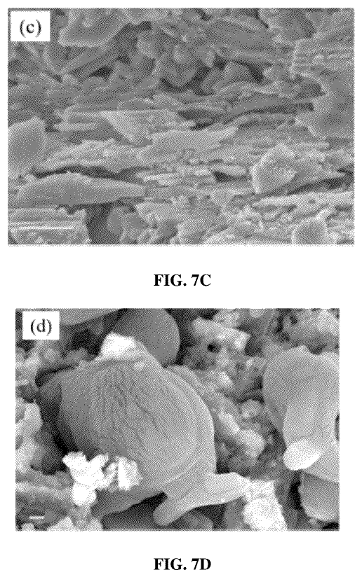

In some forms, the composite is an L-serine-containing carbonated composite containing calcite and stable ACC, vaterite, and aragonite in the matrix as measured by FITR, optionally, with approximately equal amounts of calcite, aragonite, and vaterite. The microstructure of the carbonated wollastonite containing for example, about 0.25 M of L-serine aid was highly variable at different locations within the includes semi-circular plates of vaterite crystals with a diameter around 3 to 4 The gaps between these plates were filled with smaller rhombohedral (calcite) and/or spherical (ACC) particles. In some forms, the plates were aligned parallel, resulting in a layer-like formation (FIG. 7C). Such layer-like formation has long been known to be the source of high toughness of biominerals. L-serine-containing carbonated composite include vaterite plates joined together to form large (˜10 μm) particles.

In some forms, the composite is an L-arginine-containing carbonated composite containing calcite and stable ACC, vaterite, and aragonite in the matrix as measured by FITR. The addition of L-Arg reduces the amount of calcite and increases the amounts of aragonite and vaterite, when compared to a composite formed without amino acids. In the case of a carbonated composite containing for example, about 0.25 M L-Arginine, the CaCO₃ crystal shapes are cubic, however, the sizes, measured after 300 h of carbonation, are significantly smaller (less than 1 μm) as measured by SEM, when compared to the size range of 2 to 5 μm cubic or rhombohedral crystals of calcite observed in control composites formed without amino acids. Thus, in these embodiments, L-arginine mainly affects the size of the carbonates and the primary polymorph was still calcite, though in reduced amounts when compared to control composites.

In some forms, the composite is an L-aspartic acid-containing carbonated composites containing stable ACC and vaterite in the matrix as the only CaCO₃ polymorph, as measured by FTIR, with vaterite optionally being more abundant i.e., L-aspartic acid-containing carbonated composites do not contain calcite, or aragonite, as measured by FITR. An exemplary microstructure of a carbonated composite containing 0.25 M L-aspartic acid. The microstructure of this matrix is uniform throughout the section. The formation of stable ACC is apparent from the presence of presence of spherical CaCO₃ particles with around <500 nm diameter as measured by SEM.

The disclosed composites are prepared by supplementing a silicate-containing cementitious material with one or more amino acids prior to carbonation and subjecting the amino acid supplemented silicate-containing cementitious material to carbonation using methods known in the art. One preferred embodiment is exemplified in the examples below.

The present invention will be further understood by way of the following non-limiting examples.

### EXAMPLES

### I. Amino Acids as Performance-Controlling Additives in Carbonation-Activated Cementitious Materials

### 1. Materials and Methods

### 1.1 Raw Materials

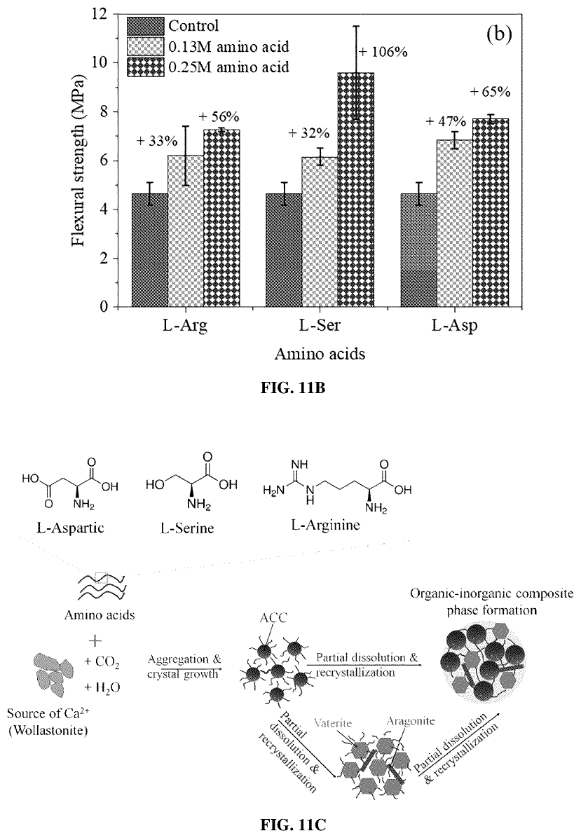

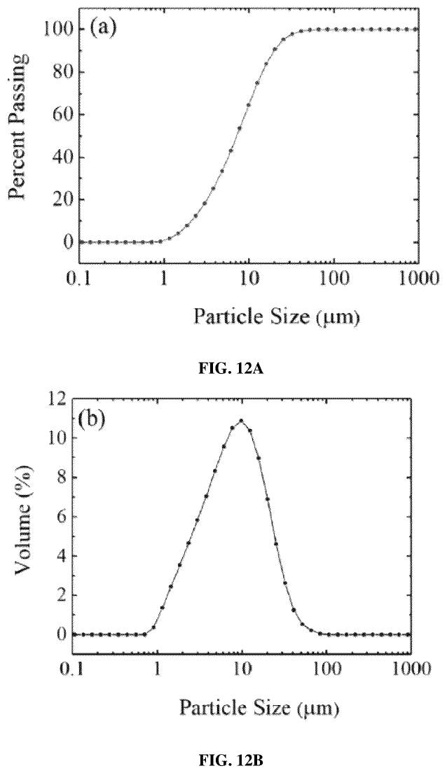

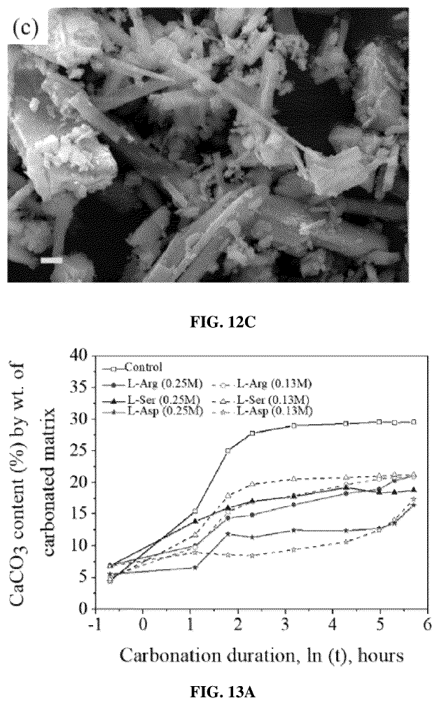

The raw materials used in this study include commercially available ground wollastonite (CaSiO3) (as a source of calcium silicate) and amino acids. Ground wollastonite was supplied by Nyco Minerals, USA, with a mean particle size of 9 μm and a specific surface area of 1.6 m2/g. Ground-natural wollastonite was used as the source of calcium silicate. Wollastonite is known as a non-hydraulic calcium silicate and do not produce calcium silicate hydrate gel due to the addition of water. Therefore, it was selected as a model calcium silicate mineral to investigate carbonation behavior without significant influence from hydration reaction. FIGS. 12A-12C and Table A show the particle size analysis and chemical composition of wollastonite.

TABLE A
Composition of wollastonite.

| | SiO₂ | CaO | Al₂O₃ | Fe₂O₃ | MgO | SO₃ | MnO | TiO₂ |
|---|---|---|---|---|---|---|---|---|
| Wollastonite | 55.0 | 43.6 | 0.463 | 0.261 | 0.457 | 0.05 | 0.04 | 0.01 |
| (weight %) | | | | | | | | |

Amino acids were purchased from VWR. Three types of amino acids were used in this study, including positively charged L-Arginine (LArg), less polar uncharged L-Serine (L-Ser), and negatively charged LAspartic (L-Asp).

### 1.2 Sample Preparation

Two categories of samples were prepared for carbonation in this study: (i) thin paste samples (<2 mm) without any compaction, and (ii) compacted paste cube and beam samples. The first category of samples (Described in Section 1.2.1) were used to monitor the CaCO3 polymorph formation and evolution over time during carbonation without the effect of CO₂ diffusion across the sample dimensions. The second category of samples (described in Section 1.2.2) were used for mechanical strength and pore size distribution analysis.

### 1.2.1. Carbonation of Thin Paste Samples without Compaction

Dry amino acids were first mixed with water at 0.13 M and 0.25 M concentrations. Using the prepared amino acid solutions, Wollastonite powder was then combined to make paste samples with a solution-to-solid ratio of 0.42. The control batch was prepared by mixing wollastonite with deionized water without amino acid by maintaining the same solution-to-solid ratio. A total of seven batches (i.e., control, 0.13 M L-Arg, 0.25 M L-Arg, 0.13 M L-Ser, 0.25 M L-Ser, 0.13 M L-Asp, and 0.25 M L-Asp) were prepared for the nano to macro-level analysis.

Amino acid solution and wollastonite were then hand-mixed for 2 approximately minutes.

After mixing, 10-15 g of the paste was spread on a petri dish having a sample thickness of less than 2 mm, and this petri dish was then placed in a commercially available carbonation chamber (CO2 incubator by VWR) where % RH, and 20% CO₂ concentration (atmospheric pressure) and 55° C. temperature was maintained. This experimental setup was found to be suitable for the carbonation of calcium silicates based on previously published studies (W. Ashraf and J. Olek (2018), Cement Concrete Composites 93, pages 85-98; W. Ashraf et al. (2016) Carbonation reaction kinetics, CO2 sequestration capacity, and microstructure of hydraulic and non-hydraulic cementitious binders in: Sustain. Constr. Mater. Technol.). A commercially available carbonation chamber (CO₂ incubator by VWR) was used to control these environmental parameters. Carbonated samples were collected from the chamber at intervals of 0.5, 3, 6, 10, 24, 72, 145, 200, and 300 h from the chamber. After the samples were removed from the carbonation chamber, they were kept in a laboratory-sealed environment for at least 24 hours before performing the characterization tests. These samples were used for microstructural analysis. To eliminate uncertainty, three to four sample sets were carbonated and analyzed to verify the results. The variation in the results was less than 5%. The samples were then examined using Thermogravimetric Analysis (TGA) with or without mass spectrometer, Fourier Transformed Infrared (FTIR) and X-ray Diffraction (XRD) to monitor the extent of carbonation and the polymorph of CaCO₃.

### 1.2.2. Carbonation of Paste Cube and Beam Samples

For mechanical performance testing, paste samples were prepared with the same mix proportions as described in Section 1.2.1. In this case, mixing was performed using a rotary mixer for 2 minutes. The samples of the paste mixtures were then poured into 25 mm cube and 12.7 mm×45 mm×20 mm beam molds. The paste mixture had low viscosity and it was relatively easy to pour the mixtures into the beam molds. Nevertheless, all the samples were lightly tamped about 10 times with a glass rod to achieve the same level of compaction.

The cube samples were exposed to CO2 containing environment, same as that described in Section 1.2.1 above, immediately after casting. The beam samples were exposed to an atmospheric pressure carbonation in a chamber with 99.9% CO₂, 55° C., 80% RH for a duration of 300 hours. A higher CO₂ concentration for beam samples was implemented to ensure maximum possible degree of carbonation. After the initial 24 hours of carbonation in the molds both, the cube and beam samples were demolded, and the carbonation process continued under the same conditions as discussed above.

In some experiments, Beam samples (40 mm×30 mm×180 mm) and disk samples (dia 25 mm, height 25 mm) were prepared using the paste mixture for fracture toughness and nanomechanical testing. After mixing, the paste samples were compacted into beam molds in two layers and vibrated for a total of 30 s using a mechanical vibrator. Beam and disk samples were then kept in a carbonation chamber at 99.9% of CO2, 80% RH, and 55° C. temperature. The beam and disk samples were demolded after 24 h of casting and were again placed in the CO2 chamber for further carbonation curing until 145 h.

### 1.3. Test Methods

Thermogravimetric analysis (TGA)

TGA was performed to determine the carbonation rate of wollastonite paste samples. A commercially available instrument (TA instrument, TGA 55) was used for the TGA measurements. The paste samples were prepared as described in Section 1.2.1 were first ground using a mortar-and-pestle to obtain powder samples. Approximately 30-45 mg of this powder sample was then tested for each batch. The powdered sample was loaded into the Platinum pan and kept under isothermal conditions for 5 minutes at 25° C. The temperature of the chamber was then raised continuously up to 980° C. with an increment of ° C. per minute. Nitrogen gas was purged in the chamber to ensure an inert environment. Initially, three replicate samples were tested through TGA for a few batches to validate for any deviation in carbonation across samples. The test result deviations were less than 2% by weight of total carbonated samples.

CaCO3 decomposes to CaO and CO2 at around 400˜800° C. To compare the effectiveness of different amino acids, the relative proportions of CaCO3 polymorphs compared to the total carbonates formed in the matrix were determined by the ratio of ‘weight loss from 400° C. to 650° C.’ to ‘weight loss from 400° C. to 800° C.’ The weight loss was calculated from 400.0 (not from 200° C.) to avoid the contribution from the evaporation of chemically-bound water, which occurs in the range of 200 to 350° C. Worthy of note, this approach underestimates the amount of mCaCO3 (metastable CaCO3) as these phases experience decarbonation in the entire range of 400° C. to 800° C. The amount of CaCO3 was calculated based on the following equation:

CaCO3 (%)=(M400−M800)×2.27 (1)

Where M₄₀₀, M₈₀₀ are the masses (%) of the samples at the given temperatures.

After calculating CaCO3, wollastonite's degree of carbonation (a) was determined using Eqn. (2) for the carbonation kinetics analysis.

Degree of carbonation, α=Amount of CaCO3 (wt %) at time, t/Maximum amount of CaCO3 (wt %) formed in the control (2)
general, the reaction kinetics of stage-1 carbonation reaction can be done using the ‘geometric contraction model’, and stage-2, which is usually controlled by the diffusion of ions through the layer of the product formed during stage-1 follows a ‘diffusion model’. Both of these mechanisms can be represented using the following equation (Eqn. 3):

[1−(1−α)13]n=kt (3)

Here ‘k’ is a reaction constant, ‘α’ is degree of carbonation, ‘t’ is carbonation time, and ‘n’ is the reaction controlling factor. In this study, ‘k’ is a relative value, as the exact k-value depends on other experimental values such as particle size, and other properties. The reaction rate constants were evaluated through the logarithmic form of Eqn. 3 as shown in Eqn. 4.

ln[1−(1−α)1/3]=1nln(k)+1nln(t) (4)

For a limited number of samples, TGA was coupled with a mass spectrometer (MS). This coupled TGA-MS system enabled the separation and identification of any volatile species coming off the sample during the heating process. In this case, TGA was performed using a Netzsch STA 449 F3 Jupiter Simultaneous Thermal Analysis (STA) instrument. All samples were measured under ultra-high purity helium gas (flow of 50 ml/minute). The temperature was increased at a rate of 10° C./minute and gases were transferred to the GC/MS instrumentation via a heated (250° C.) transfer line. An Agilent Technologies 7890A GC system equipped with a non-polar capillary column (Agilent J&B HP-5 packed with [5%-phenyl-methylpolysiloxane]) coupled with a 5975 MSD spectrometer was used for the analyses of the gases released from the samples. A gas injection was triggered every minute (60 seconds) from the beginning of the heating cycle, and 0.25 ml of gas was sampled from the gases released by the compound and carrier gas (He).

X-Ray Diffraction (XRD)

X-ray Diffraction (XRD) patterns of the carbonated powdered samples were recorded via Bruker D-8 spectrometer using a Cu Kα radiation (40 kV, 40 mA). The diffraction patterns were obtained for the 2θ range of 5° C. to 60° C. using a step size of 0.02 (2θ) per second. For additional series of samples, 10 wt. % of TiO₂ was used as the internal standard for performing Rietveld refinement. The Rietveld refinement was performed using a commercially available software (Match! Phase Analysis using Powder Diffraction). The PDF card numbers used were as follows: PDF #96-900-5779, PDF #96-901-5391, PDF #96-901-3800, PDF #96-901-5899, and PDF #96-7250-6076 for wollastonite, calcite, aragonite, vaterite and TiO₂, respectively. However, due to the possible error in calculations, the obtained phase proportions were regarded as semi-quantitative.

Scanning Electron Microscopy (SEM)

Scanning Electron Microscopy (SEM) images were obtained using a Zeiss-FIB SEM which was operated in high vacuum mode, using an accelerating voltage of 5 kV. Fractured surfaces of the samples were coated with gold-palladium to achieve adequate conductivity.

Fourier-Transformed Infrared (FTIR)

The Fourier-Transformed Infrared (FTIR) spectra of the ground paste sample was collected using Attenuated Total Reflection (ATR) mode with 4 cm⁻¹ resolution and 16 scans for each sample. Signal to noise ratio was lower than 3:1.

The 5×5×5 mm paste cube samples were removed from the 25 mm cubes (curing condition as described in Section 1.2.2) for porosity evaluation. FIG. 1 shows the location of the test samples. A slow speed diamond saw was used to remove the samples. Pore size distributions of the samples were evaluated using mercury intrusion porosimeter (MIP).

The cube and beam samples prepared as per Section 1.2.2 were used for compressive and flexural strength tests, respectively. The compression test was performed at a displacement rate of 0.02 mm per second. The flexural strengths of the carbonated paste samples were measured in 3-point bending mode using a displacement rate of 0.3 mm per second.

Nanoindentation

Nanoindentation tests were performed on 145 h of carbonated disc paste samples. The discs were polished so that the surface became mirrorlike. The method of obtaining a mirrorlike shiny surface can be found elsewhere. The load function had three segments: (i) loading from zero to maximum load in the span of 5 s, (ii) holding at the maximum load for 5 s, (iii) unloading from maximum to zero loads within 5 s. Since the depth of the indentations should also be small enough to determine the mechanical properties of the individual microscopic phases (i.e. indentation depth <characteristic size of each microscopic phase), a maximum of 2500 μ-N force was selected for the SNI technique during this study. The average indentation depth for this load function was kept in the range of 100-300 nm for a 50 μm×50 μm area. The elastic moduli were determined from the load-depth plots using the Oliver and Pharr method. The experiment was performed using a Hysitron Triboindenter UB1 system (Hysitron Inc. Minneapolis, USA) fitted with a Berkovich diamond indenter probe. Throughout the test, a surface RMS roughness lower than 75 nm (measured with the Berkovich tip) was detected over an area of 5011 m×5011 m.

Inductively Coupled Plasma-Optical Emission Spectrometry (ICP-OES)

Inductively coupled plasma-optical emission spectrometry (ICP-OES) measurements were used to determine the leaching of Ca2+ and Si2+ ions. Beam samples carbonated for 145 h were used for this test. 100 g of sample from the tested beam were soaked in 400 g of deionized water for up to 48 h at ° C. The water to sample weight ratio was 4:1. After 6 h, 24 h, and 48 h, the samples were removed from the water, and the remaining water was filtered and tested for ICP-OES. After 48 hours, the soaked samples were placed in a vacuum chamber, and the TGA and FTIR tests were performed to check for any alteration in CaCO₃ polymorphs due to the moisture exposure at 60° C.

Fracture Toughness Test

Notched beam tests determined the fracture properties and roughness of the prepared carbonated beam samples. After carbonation for 145 h, a notch (one-third of beam depth) was made at the middle of the beam and tested in a closed-loop Instron machine with a displacement rate of 0.015 mm/min using a crack-mouth opening displacement (CMOD) control mode. Critical effective crack length, ac was calculated based on the change between loading and unloading compliance. In addition, the total work of fracture, or fracture energy, Gf, was evaluated by taking the area under the load-CMOD curves, less the unloading-reloading portion. Critical effective crack length is considered as a measure of crack initiation toughness, while fracture energy is a measure of crack propagation toughness.

### Results

### 2.1. Polymorph Identification of Metastable CaCO₃

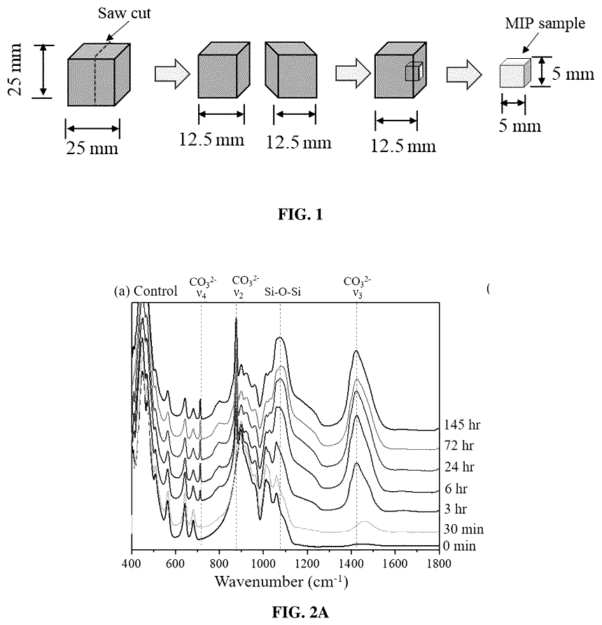

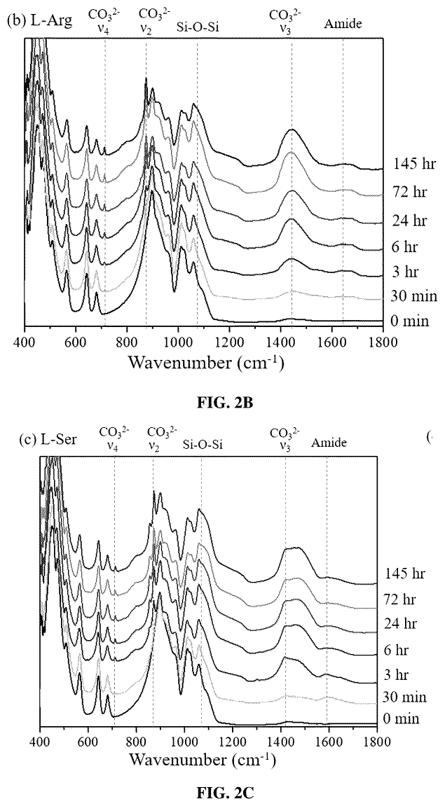

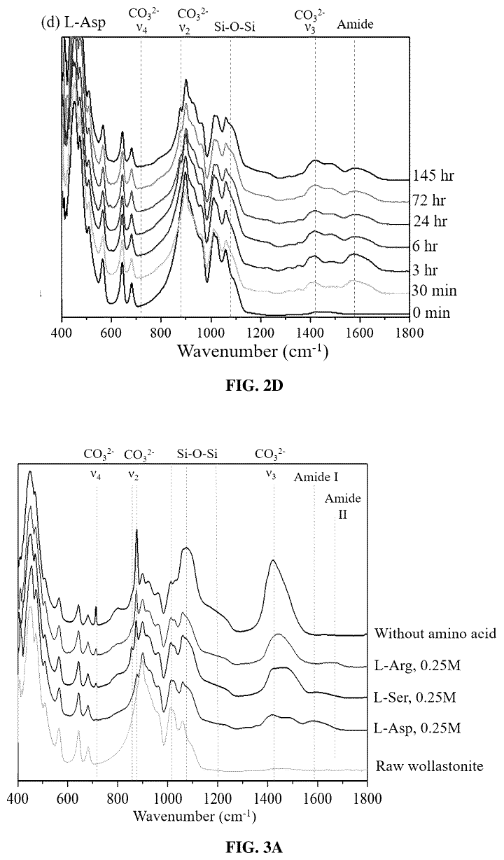

FTIR spectra and XRD patterns were collected to identify the polymorphs of CaCO3 formed in the carbonated wollastonite composites with and without amino acids. FIGS. 2A-D show the FTIR spectra of these composites after different carbonation durations. The peaks below 700 cm⁻¹ wavenumbers originated from raw wollastonite. The broad absorptions between 800 cm⁻¹ and 1200 cm⁻¹ in the FTIR spectra of unreacted wollastonite (0 min, FIG. 2A) correspond to the asymmetrical stretching vibration (v3) of the Si—O bond in this mineral (I. F. Del Bosque, et al. (2014) Construction and Building Materials 52: pages 314-323). The absorption bands of pure wollastonite at or below 800 cm⁻¹ corresponds to the out-of-plane skeletal (v4) and in-plane skeletal (v2) vibrations of the Si—O bond (Y. Okada, et al. (1994) Journal of the Ceramic Society of Japan 102 (1190): pages 919-924); M. Yousuf, et al. (1992) Journal of Environmental Science and Health Pt. A: Environmental Science and Engineering Toxicology 27(6): pages 1503-1519). During the carbonation, the gradual removal of Ca²⁺ from wollastonite increases the silicate polymerization (W. Ashraf, and J. Olek (2018), Journal of CO₂ Utilization 23 (2018), pages 61-74), which is reflected by the shift of the v3 vibration of the Si—O bond to a higher wavenumber resulting from the increased bond strength (Y. Okada, et al. (1994) Journal of the Ceramic Society of Japan 102 (1190): pages 919-924); P. Yu, et al. (1999) Journal of the American Chemical Society 82(3): pages 742-748).

The absorption bands for CaCO3 polymorphs based on the literature are given in Table 2.

TABLE 2
Wavenumbers (cm⁻¹) of FTIR absorption
peaks for different CaCO₃ polymorphs

| | | In-plane | | |
|---|---|---|---|---|
| CaCO₃ | Symmetric | Bending | Stretching | Out of plane |
| polymorphs | Stretch (v₁) | (v₁) | vibration (v₃) | bending (v₄) |
| Calcite | 1080 | 872 | 1420 (relatively | 712 |
| | | | narrow) | |
| Aragonite | 1083 | 856 | 1450, 1470 | 700, 712 |
| Vaterite | 1087 | 876 | 1490, 1450 (broad | 744 (broad |
| | | | peak) | peak) |
| ACC | 1067 | 864 | 1420, 1480 (split | Absent or |
| | | | peak) | very broad |
| | | | | peak |

The symmetric stretch (v1) of carbonate minerals at around 1080 cm⁻¹ is often used to differentiate polymorphs of CaCO₃ (D. Chakrabarty, and S. Mahapatra (1999), Journal of Material Chemistry 9: pages 2953-2957). However, this peak was overlapped by the v3 peak of the Si—O bond in the carbonated wollastonite composites, and hence, was not usable for CaCO3 polymorph identification.

The information presented in Table 2 was used to identify the CaCO3 polymorphs present in carbonated wollastonite composites based on FTIR spectra.

The control batch contained ACC and/or vaterite after 30 minutes of carbonation, as identified by the broad peak at 1480 cm⁻¹, due to the v3 vibration of CO²⁻₃ (FIG. 2A). The control batch exhibited structural rearrangement of carbonate phases after 3 hours of carbonation, as was apparent by the shift and narrowing of the v3 peak at 1420 cm⁻¹. The relatively sharp peak at around 1420 cm⁻¹ was indicative of stable calcite formation in this system (M. Sato and S. Matsuda (1969) Zeitsch. Krist. (New Cryst. Struct.) 129: pages 405-410). The sharp in-plane bending (v4) at 712 cm⁻¹ and the out-of-plane bending (v2) at 872 cm⁻¹ also confirmed the presence of only calcite polymorphs in this system (FIG. 2A). The v3 vibration of the Si—O bond at 1100 cm⁻¹ and 1200 cm⁻¹ indicated the formation of highly polymerized silica gel networks in this composite (J. M. Bukowski and R. L. Berger (1979) Cement and Concrete Research 9: pages 57-68).

The v3 vibration of CO²⁻₃ in the L-Arginine-containing carbonated composites were around 1450 cm⁻¹ (FIG. 2B), indicating the formation of aragonite in these systems (C. E. Weir and E. R. Lippincott (2012) J. Res. Natl. Bur. Stand. Sect. A Phys. Chem. 65A: pages 173-180). A small peak of carbonate out-of-planebending vibration (v2) at 856 cm⁻¹ was observed after 72 hours of carbonation, which is also the characteristic of aragonite (D. Chakrabarty, and S. Mahapatra (1999), Journal of Material Chemistry 9: pages 2953-2957). Nevertheless, all other typical calcite peaks (712 cm⁻¹ and 872 cm⁻¹) were present in the FTIR spectra of L-arginine-containing carbonated composites, confirming calcite was still the primary polymorphs of CaCO3 in these samples. The additional peak at around 1640 cm⁻¹ as observed in FIG. 2B was an overlap between the OH bend present in the bound water of calcium carbonate with the amide-I vibration of amino acids (W. Gallagher (1958) Nature 18: pages 662-666).

The L-serine-containing carbonated composite showed similar FTIR characteristics to the L-arginine batch after 30 minutes of carbonation (FIG. 2C). After 3 hours of carbonation, the v3 vibration of the L-Serine batch presented a broad peak in the range of 1420 cm⁻¹ to 1490 cm⁻¹ representing the typical characteristics of vaterite and ACC (M. Sato and S. Matsuda (1969) Zeitsch. Krist. (New Cryst. Struct.) 129: pages 405-410). The peak at 712 cm⁻¹ was short (compared to the control) for L-serine batches, indicating the presence of only a small amount of calcite. The formation of stable aragonite in this system was identified by the v2 peak of carbonate ions at 856 cm⁻¹ after 3 hours of carbonation (FIG. 2C). All the above-specified observations confirmed that L-serine-containing carbonated composites had stable ACC, vaterite, and aragonite in the matrix.

The split v3 peak of carbonate ions around 1420-1480 cm⁻¹, as observed in the L-aspartic acid batches (FIG. 2D), indicated the presence of ACC in these composites. The split v3 peak results from the lack of symmetry in CO²⁻₃ ions, which are the characteristic of the ACC phase (L. Addadi, et al. (2003) Advanced Materials 15(12): pages 959-970). The in-plane bending (v4) at 712 cm⁻¹ was completely absent in the L-aspartic acid batches, confirming that calcite was not present in these samples. No trace of aragonite was observed in L-aspartic acid containing composites. Therefore, ACC was the primary CaCO₃ polymorph formed in the L-aspartic acid-containing composites.

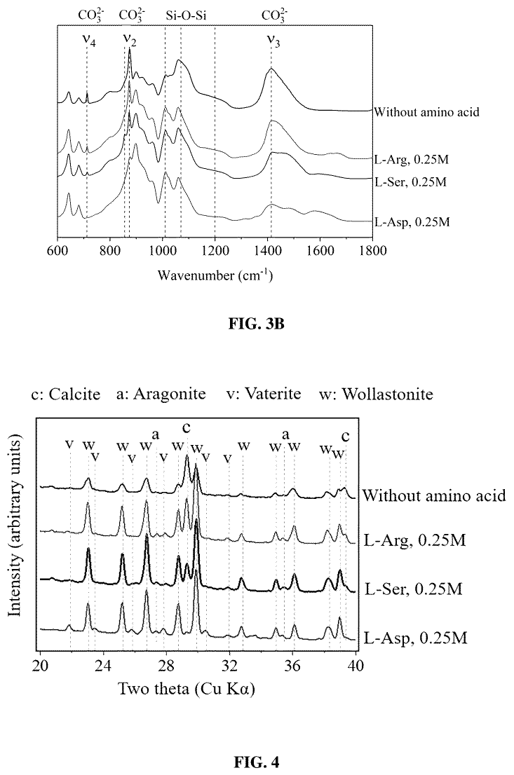

A comparison of the FTIR spectra of carbonated composites after 145 hours of carbonation with and without amino acids (0.25 M) is given in FIG. 3A. The characteristic in-plane bending (v4) at 712 cm⁻¹ for calcite was most intense for the control batch without any amino acid. With the addition of amino acids, v4 at 712 cm⁻¹ was reduced or disappeared, the out-of-plane bending at 872 cm⁻¹ (calcite) became shorter or shifted to 856 cm⁻¹ (aragonite), and the v3 peak at around 1420 cm⁻¹ became broader (in the case of L-Arg and L-Ser) or showed split peaks (in case of L-Asp). These changes in CO²⁻₃ confirm that the addition of amino acids reduced the amounts of calcite formation and stabilized the typically metastable CaCO3 polymorphs, including ACC, vaterite, and aragonite, at room temperature in carbonated composites. Moreover, the 3D-networks of silicate species (Si*-(OSi)3) that are present in silica gel, as identified by the absorption peaks at around 1100 cm⁻¹ and 1200 cm⁻¹, were most intense in the batch without any amino acid. With the addition of amino acids, these peak intensities for silica gel were reduced (FIG. 3A). Thus, these results revealed that the amount of fully polymerized silica gel in carbonated cement composites can be lowered by introducing amino acids in these systems. Noteworthy, additional batches of this 145-hour carbonation cured carbonated composites containing amino acids were kept in a lab environment (room temperature, 50-60% RH) for two years. The FTIR spectra of the two years old samples are given as FIG. 3B. As observed from FIG. 3B, after the two years of exposure, the FTIR spectra of these samples are similar to those shown in FIG. 3A. Specifically, the L-Asp containing specimens still did not show any calcite peaks after two years of exposure to laboratory environment (23° C., 50 to 60% RH). The v3 peaks for all the amino acid-containing batches also remained the same. These findings indicate that the presence of amino acids stabilized the formed aragonite, vaterite, and ACC for an extended period of time (at least two years), if not permanently.

XRD patterns of the wollastonite matrixes carbonated for 145 hours with and without amino acids are given in FIG. 4. The XRD patterns supported the above-discussed findings of FTIR spectra. That is, calcite was the only polymorph of CaCO₃ present in the control batch. On the other hand, the batches containing amino acids had typical forms of mCaCO₃. After the control batch, the L-arginine batch had the second-highest intensity for calcite followed by the L-serine batch. The L-aspartic acid batch did not have any peak for calcite, confirming this polymorph was not present in the L-aspartic acid batches. Vaterite and aragonite were present in both the L-serine and L-arginine batches. The presence of ACC was not observed in the XRD patterns due to the relatively small amount (compared to the raw wollastonite) and the lack of crystallinity in that phase.

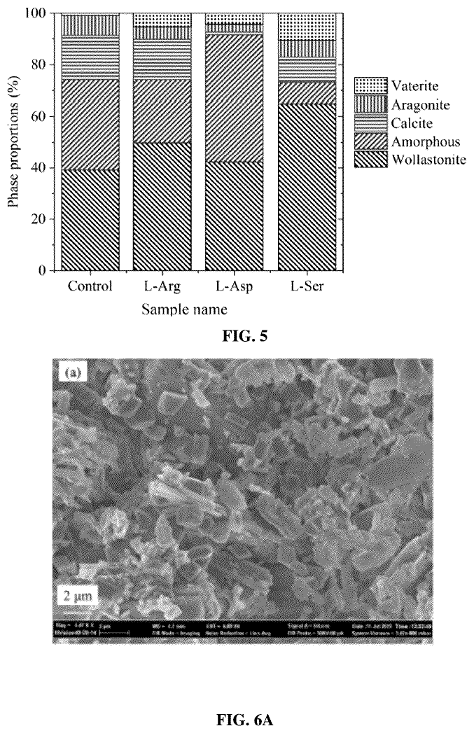

Rietveld refinement was performed to compare the relative proportion of the phases (FIG. 5) in the carbonated wollastonite systems. Important to note, the amorphous phase in XRD contains amorphous calcium-silica gel (carbonation reaction product), ACC, and part of unreacted wollastonite. Nevertheless, L-Asp containing batch showed the highest amount of amorphous phase present in the carbonated system, indicating the presence of ACC. The amount of unreacted wollastonite was highest in L-Ser containing batch and lowest for the control batch. This finding further confirms that the addition of amino acids reduced the carbonation extent of wollastonite. The control batch was found to contain primarily calcite form of CaCO₃ with relatively small amounts of aragonite and vaterite. The addition of L-Arg reduced the amount of calcite and increased the amounts of aragonite and vaterite. Interesting to note, calcite was not observed to form in the L-Asp containing batch of specimens. Among the crystalline polymorphs of CaCO₃, vaterite was the most abundant phase in the L-Asp containing batch. L-Ser-containing batch of specimens was found to have nearly equal amounts of calcite, aragonite, and vaterite.

### 2.2. Morphology of the CaCO3 Particles

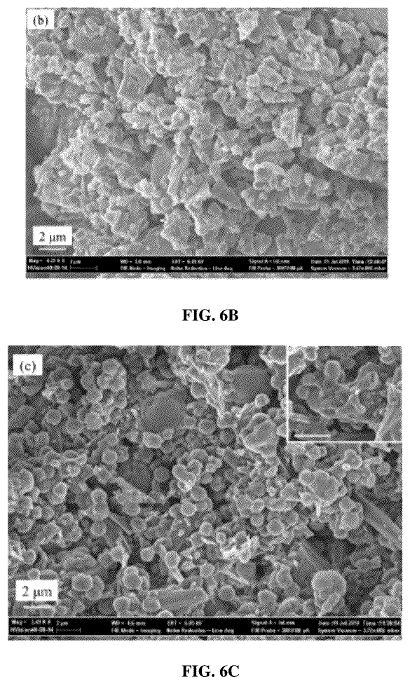

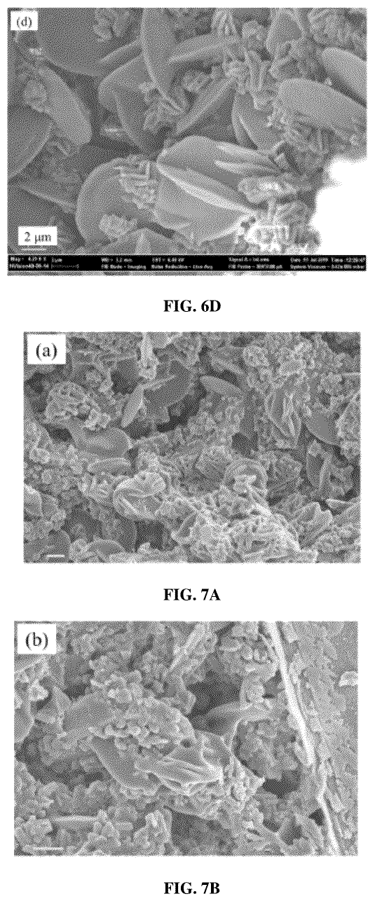

The SEM images were used to examine the effects of amino acids on the morphology of CaCO₃ particles in the carbonated composites (FIG. 6A-D). The SEM images were collected from carbonated composites after 300 hours of carbonation. Cubic or rhombohedral crystals of calcite were prominent in the control batch (FIG. 6A). For this sample, the sizes of the calcite crystals were in the range of 2 to 5 μm. In the case of a carbonated composite containing 0.25 M L-Arginine, the CaCO3 crystal shapes were still cubic, however, the sizes were significantly smaller (less than 1 μm, FIG. 6B). Thus, L-arginine mainly affected the size of the carbonates, and the primary polymorph was still calcite. This matches the finding of FTIR and XRD regarding the L-arginine batches.

The presence of aragonite in this system, as observed from FTIR and XRD (FIGS. 2A-2D and FIG. 4, respectively), was challenging to identify in the SEM images. This is due to the relatively small amount of this phase present in the composite. (FIG. 76C) The microstructure of the carbonated composite containing 0.25 M L-aspartic acid was uniform throughout the section. The formation of stable ACC was apparent from the presence of spherical CaCO₃ particles with around <500 nm diameter. The spherical ACC particles merged in several locations, which gave a binding capacity to the matrix (FIG. 6C inset). The microstructure of the batch containing 0.25 M of L-serine batch was found to have circular platy phases. Based on the FTIR and XRD data, these platy phases were identified to be vaterite crystals. Noteworthy, unlike aragonite and calcite, vaterite can show wide variability in the morphologies depending on the experimental conditions (R. J. Qi and Y. J. Zhu (2006) Journal of Physical Chemistry B 110 (16): pages 8302-8306; B. G. Mao, et al. (2013) European Journal of Inorganic Chemistry 2013(35) pages 5958-5963).

The microstructure of the carbonated wollastonite containing 0.25 M of L-serine aid was highly variable at different locations within the composite (FIG. 7A-7D). The semi-circular plates of vaterite crystals were the most prominent phase throughout the microstructure (FIG. 7A) The diameter of these plates in most of the locations was around 3 to 4 μm. The gaps between these plates were filled with smaller rhombohedral (calcite) and/or spherical (ACC) particles. The vaterite plates were also connected to form ‘flower-like’ shapes (FIG. 7B). However, in a few locations, the plates were aligned parallel, resulting in a layer-like formation (FIG. 7C). Such layer-like formation has long been known to be the source of high toughness of biominerals (E. Macias-Sanchez et al. (2017) Science Reports 7: pages 1-11). However, in some other locations, the vaterite plates were joined together to form large (˜10 μm) particles (FIG. 7C). These particles also had parallel crack lines induced by volumetric change. These cracks likely formed due to the high vacuum pressure of the SEM chamber. The porosity around such large vaterite particles was also higher compared to other locations in the L-serine batch as well as in other batches.

### 3.3. Relative Quantification of mCaCO3 Polymorphs and Extent of Carbonation

As discussed in the previous sections, from the FTIR, XRD, and SEM investigations, it was apparent that the presence of amino acids stabilized typical mCaCO₃ polymorphs including ACC, vaterite, and aragonite, in the carbonated composites. In this section, TGA with/without mass spectra (MS) was used to determine the relative proportions of mCaCO₃ formed in the composites and their effects on the extent of carbonation.

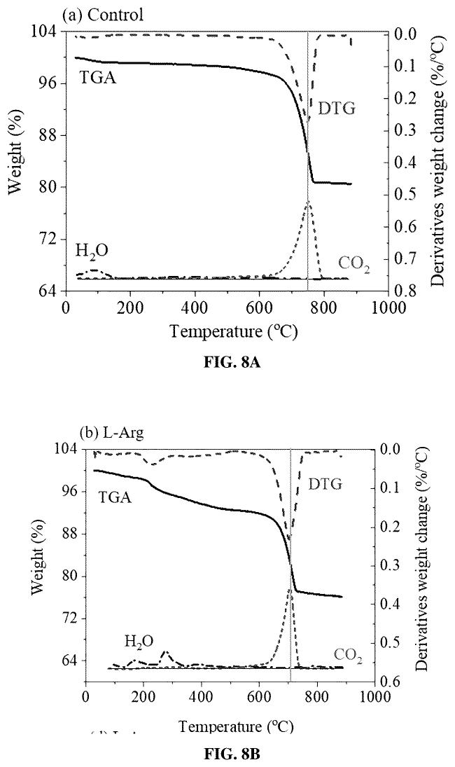

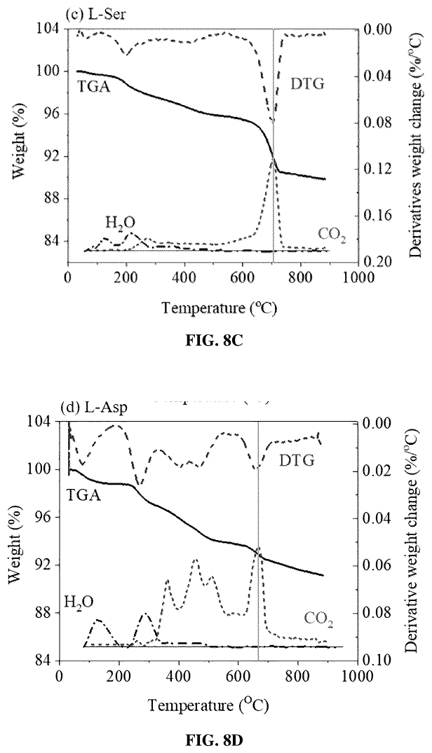

FIGS. 8A-8D show the typical TGA-MS plots of carbonated composites with and without amino acids. The H₂O and CO₂ mass spectra were used to identify the origin of weight loss during the TGA measurements. As it can be observed from FIG. 8E, the control batch showed minor weight loss due to dehydration at 100° C.; major weight loss due to the decarbonation occurred in the temperature range of 650° C. to 800° C. with the peak at 750° C. The former weight loss was attributed to the evaporation of free water from the matrix and the later weight loss was attributed to the decomposition of CaCO₃ (W. Ashraf, and J. Olek (2018), Journal of CO₂ Utilization 23 (2018), pages 61-74). Comparing these results with those of FTIR (FIG. 2A and XRD (FIG. 3)), the sharp weight loss at 750° C. is the characteristic of decarbonation of calcite polymorphs of CaCO3. The L-arginine-containing carbonated matrix showed an additional weight loss due to the release of H₂O at around 300° C., which indicated the presence of chemically bound water in this matrix (FIG. 8B). This weight loss was attributed to the decomposition of amino acids (I. M. Weiss et al. (2018) BMC Biophysics 11: Article number 2) and possible dehydration of mCaCO₃ (Ihli, et al. (2014) Nature Communication 5: article 3169). Furthermore, the decomposition of CaCO3 in this sample occurred at a lower peak temperature (700° C.) compared to the control batch (750° C.). Such variation in the lower decomposition temperature of CaCO₃ was attributed to the presence of aragonite and smaller calcite crystal sizes than those observed from FTIR (FIG. 2B), respectively, of this sample. Both L-serine and L-aspartic acid containing batches showed similar weight loss as that of L-arginine, due to the evaporation of free water at 100° C. and chemically bound water at 300° C. (FIGS. 8C and 8D). These samples also showed a gradual weight loss and a sharp weight loss due to the release of CO₂ in the temperature ranges of 200 to 650° C. and 650° C. to 800° C., respectively, as observed from the TGA-MS plots. Comparing these TGA-MS plots with FTIR and SEM images, it is postulated that the decarbonation of vaterite (present in the L-Serine batch) and ACC (present in the L-aspartic acid batch) occurs gradually within the temperature range of 200° C. to 650° C. Such gradual decarbonation was attributed to the poor crystalline nature of these polymorphs of CaCO3. The sharp weight loss in the temperature range of 650° C. to 800° C. with the peak at 700° C. was attributed to the decarbonation of recrystallized mCaCO₃.

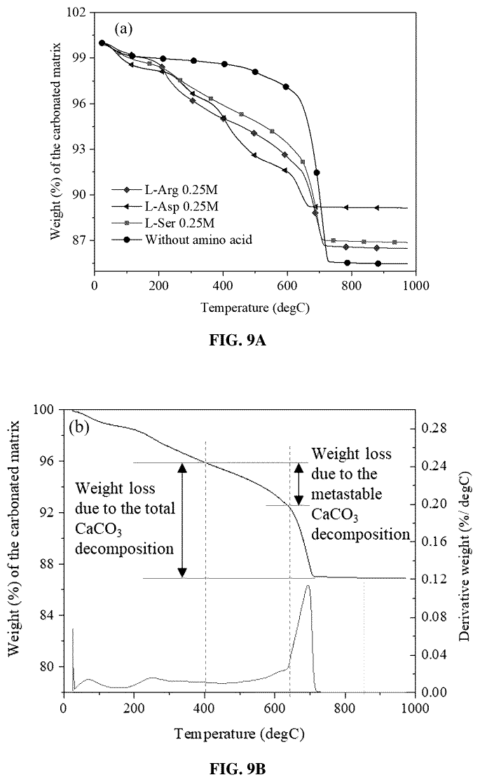

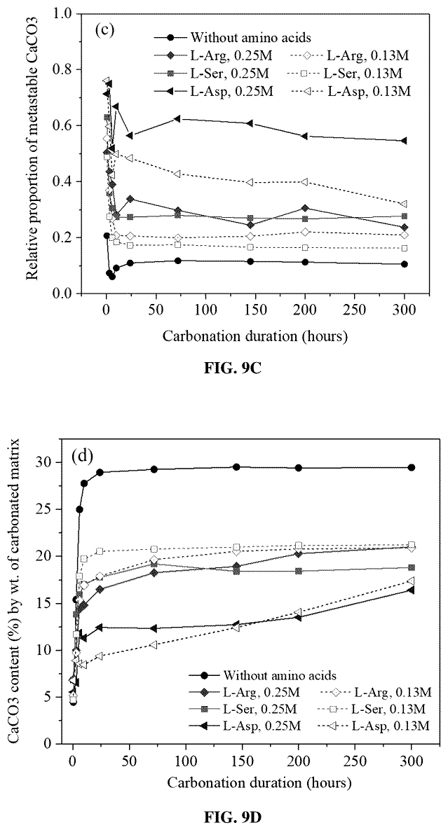

Based on these TGA-MS, FTIR, and SEM result comparisons, the gradual weight loss in the temperature range of 200° C. to 650° C. can be considered as the characteristic indicator of mCaCO₃ (specifically, for ACC and vaterite) formation in the carbonated matrix. Several previous studies also reported a lower decomposition temperature for vaterite and ACC (1111i, et al. (2014) Nature Communication 5: article 3169; Chakoumakos, et al. (2016) Science Reports 6(article number 36799):pages 1-9). As observed from FIG. 9A, at higher amino acid content (0.25 M), almost all the carbonated matrixes showed this gradual weight loss in the temperature range of 200° C. to 650° C. To compare the effectiveness of different amino acids, the relative proportions of mCaCO₃ compared to the total carbonates formed in the matrix was determined by the ratio of ‘weight loss from 400° C. to 650° C.’ to ‘weight loss from 400° C. to 800° C.’ The weight loss was calculated from 400° C. (not from 200° C.) to avoid the contribution from the evaporation of chemically bound water which occurs in the range of 200 to 350° C. Worthy of note, this approach underestimates the amount of mCaCO3 as these phases experience decarbonation in the entire range of 400° C. to 800° C. Nevertheless, this approach provides a good semi-quantification of the mCaCO3, specifically for ACC, which is difficult to quantify using traditional XRD (W. Ashraf, and J. Olek (2018), Journal of CO₂ Utilization 23 (2018), pages 61-74). The relative proportions of mCaCO₃ as determined using the above-specified approach with different carbonation duration are given in FIG. 9C.

All the carbonated composites showed relatively high mCaCO3 content at the early stage of carbonation that gradually reduced, and eventually, the relative proportion of this phase became nearly constant irrespective of the carbonation duration (FIG. 9C). This high amounts of mCaCO3 in the initial stage was expected, since in this stage, the matrixes contain relatively small amounts of CaCO3 and plenty of amino acids for stabilization. With increasing degree of carbonation, more amino acids start getting utilized which may lead to a local depletion of amino acid. Such a process can cause non-uniformity in the microstructure, resulting in the variation in the relative proportions of mCaCO3 as those observed in FIG. 9C. In case of the control batch without any amino acid, the relative proportions of mCaCO₃ became constant around 10 hours. The stabilization of this small amount of mCaCO₃ in the control batch was attributed to the formation of silica gel during carbonation. Previous studies have also shown that the presence of silica can stabilize mCaCO₃ (Ashraf, et al. (2018), Journal of CO₂ Utilization 23 (2018), pages 61-74; Kellermeier, et al. (2010), Journal of the American Chemical Society 132 (50), pages 17859-17866). With the addition of amino acids, the relative proportions of mCaCO3 were increased in the carbonated composites. Specifically, L-Aspartic acid was found to be the most effective amino acid to increase the proportion of mCaCO3. As expected, for all the amino acids, 0.25 M concentration resulted in higher amounts of mCaCO3 stabilization compared to 0.13 M.

The weight loss from 400 to 800° C. was further used to calculate the amount of total CaCO3 formed in the carbonated samples using the stoichiometric equation (CaCO3→CaO+CO₂). The amounts of CaCO₃ (% by wt of the carbonated sample) are given in FIG. 9D. As it can be observed from this figure, the addition of amino acids resulted in lower amounts of CaCO₃ formation compared to the control batch after the same carbonation duration. Specifically, 0.25 M L-aspartic acid resulted in the lowest amount of CaCO₃ formation in the carbonated composite after 300 hours of carbonation. The control batch contained approximately 1.5 times more CaCO₃ compared to the batches with amino acids after 300 hours of carbonation. Comparing FIGS. 9C and 9D, a trend between the relative proportions of metastable CaCO₃ and total CaCO₃ after 300 hours of carbonation curing is visible. Specifically, higher amounts of mCaCO₃ resulted in lower amounts of total CaCO₃ in the carbonated composites. The relative proportions of metastable CaCO3 in terms of percentage change when compared to control is shown in Table 3.

TABLE 3
relative proportions of metastable CaCO3 in terms of
percentage change when compared to control following carbonation

| Carbonation | | | | | | |
|---|---|---|---|---|---|---|
| duration | Arg | Ser | Asp | Arg | Ser | Asp |
| Hour | 0.25 | 0.25 | 0.25 | 0.13 | 0.13 | 0.13 |
| 0.5 | 288.539 | 551.1 | 661.802 | 377.83 | 264.724 | 1001.72 |
| 3 | 877.993 | 606.816 | 1264.66 | 641.784 | 380.134 | 1547.03 |
| 6 | 902.749 | 589.618 | 2991.61 | 473.959 | 291.22 | 1064.47 |
| 10 | 289.138 | 273.113 | 1109.87 | 161.007 | 125.007 | 747.18 |
| 24 | 315.683 | 206.169 | 1068.28 | 111.432 | 70.6242 | 567.956 |
| 72 | 217.998 | 190.652 | 1579.73 | 86.8415 | 58.488 | 485.955 |
| 145 | 148.945 | 184.042 | 1060.24 | 98.529 | 53.2193 | 314.372 |
| 200 | 246.259 | 187.2 | 751.428 | 122.822 | 55.3425 | 432.868 |
| 300 | 164.661 | 225.659 | 718.267 | 125.719 | 65.3863 | 520.666 |

The relative proportions of total CaCO3 in terms of percentage change when compared to control is shown in Table 4.

TABLE 4
Relative proportions of total CaCO3 in terms of percentage
change when compared to control

| Carbonation | | | | | | |
|---|---|---|---|---|---|---|
| duration | Arg | Ser | Asp | Arg | Ser | Asp |
| Hour | 0.25 | 0.25 | 0.25 | 0.13 | 0.13 | 0.13 |
| 0.5 | 55.2887 | 53.2957 | 24.2656 | 15.534 | 4.85439 | 52.3249 |
| 3 | −35.047 | −10.313 | −57.567 | −36.82 | −23.966 | −42.169 |
| 6 | −42.655 | −36.309 | −52.764 | −38.718 | −28.482 | −65.873 |
| 10 | −46.678 | −38.723 | −59.329 | −39.043 | −29.018 | −69.566 |
| 24 | −43.108 | −38.689 | −57.135 | −38.179 | −29.152 | −67.63 |
| 72 | −37.663 | −34.48 | −57.927 | −32.888 | −29.03 | −63.859 |
| 145 | −35.881 | −37.714 | −56.905 | −30.508 | −28.93 | −58.014 |
| 200 | −31.097 | −37.459 | −54.131 | −29.375 | −28.1 | −52.278 |
| 300 | −28.782 | −36.23 | −44.387 | −29.144 | −28.019 | −41.072 |

Considering the amount of total CaCO₃ to be an indication of the degree of carbonation of the wollastonite, it can be suggested that a higher amount of mCaCO₃ formation and stabilization resulted in a lower degree of carbonation. This effect can be attributed to the following reasons:

(i) The solubility constants for calcite, aragonite, and vaterite are 10-8.48, 10-8.34, and 10-7.91, respectively (L. N. Plummer and E. Busenberg (1982) Geochimica et Cosmochimica Acta 46(6), pages 1011-1040; D. Ren, et al. (2011) Micron. 42(3): pages 228-245). ACC is 120 times more soluble than calcite (Meiron et al. (2011) Journal of Bone and Mineral Research 26(2): pages 364-372). As suggested by previous studies (Dhami et al. (2016) Ecological Engineering 94: pages 443-454), due to the high solubility of ACC, the formation of this phase makes the available solution saturated with Ca²⁺ and carbonate ions. This process, in turn, reduces the dissolution rates of calcium silicates and CO₂ in solution, and thus, also reduces the extent of carbonation (Dhami et al. (2016) Ecological Engineering 94: pages 443-454). A similar mechanism for reduced degrees of carbonation due to the formation of other mCaCO₃ composites (vaterite/aragonite) also occurs because of their high solubility compared to calcite (stable CaCO₃).

(ii) The carboxyl groups (COOH—) of amino acids have an unpaired electron that can bind with the Ca²⁺ ions present in wollastonite to balance the charge. This causes the amino acids to adhere to the wollastonite, resulting in a reduction of the surface area available for reaction. Such reduction of reaction sites also contributed to the observed lower degree of carbonation with the addition of amino acids. In support of this, it should be noted that L-aspartic acid, containing two negatively charged carboxyl groups (COOH—), showed the lowest CaCO3 formation compared to the other two amino acids, which contain one carboxyl site.

(iii) The densities of CaCO₃ polymorphs are: vaterite: 2.66 g/cm³, aragonite: 2.93 g/cm³, calcite: 2.71 g/cm³, ACC: 1.62-2.59 g/cm³ depending on the H₂O content (Saharay, et al. (2014) Journal of Physical Chemistry 117(12): pages 3328-3336). Because of such difference in density, the formation of the same amount (by weight) of vaterite and ACC, as opposed to calcite or aragonite, is understood to alter the pore size distribution of the carbonated composites (Ashraf, et al. (2018), Journal of CO₂ Utilization 23 (2018), pages 61-74). As a result, the diffusivity of CO₂ in the carbonated composites can be affected if ACC or vaterite are stabilized as opposed to calcite or aragonite. A possible lower CO₂ diffusivity within the matrix, caused by different polymorphs of CaCO₃, will eventually lead to a lower degree of carbonation.

### 2.4. Effects of Metastable CaCO3 on Pore Size Distributions

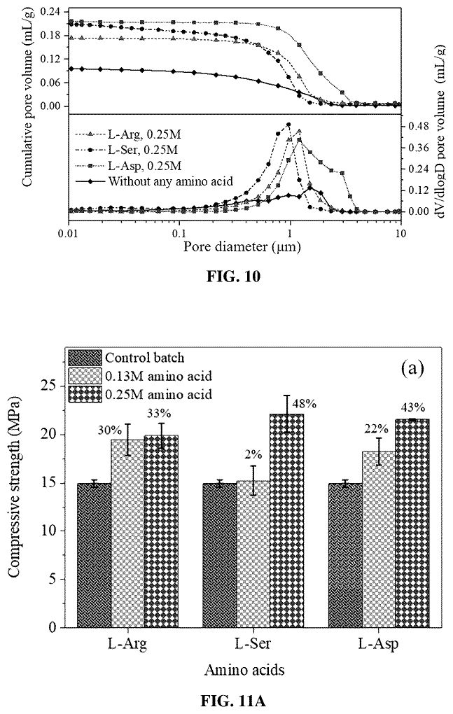

The pore size distributions of the carbonated composites, as determined using the Mercury Intrusion Porosimeter (MIP), are given in FIG. 10. The total pore volume in the range of 0.1 to 5 μm was higher in the amino acid containing batches than in the control batch. However, the addition of amino acids was found to reduce the critical pore size (size of the pore with maximum volume) of the matrix. The critical pore diameters of the control, L-aspartic acid, L-serine, and L-arginine batches were 1.33 μm, 1.07 μm, 0.86 μm, and 1.07 μm, respectively. The median pore sizes (i.e., sizes for which 50% of the pores were smaller and 50% were larger) of the control, L-aspartic acid, L-serine, and L-arginine batches were 0.78 μm, 1.4 μm, 0.74 μm, and 1.0 μm, respectively. Thus, the addition of amino acids resulted in a refinement of pore sizes in the carbonated composites (based on the critical pore diameter), even though the total porosity was increased. The reduction of pore size distribution was most apparent in the case of the L-Serine containing carbonated composites.

### 2.5. Effects of Metastable CaCO3 on Compressive and Flexural Strengths

The effects of the amino acids on the compressive and flexural strengths of the carbonated composites are presented in FIGS. 11A and 11B, respectively. As observed from these figures, both flexural and compressive strengths of the carbonated wollastonite showed increasing trends with the increasing amino acids contents. The flexural strengths of the beam were increased by 33% to 47% due to the addition of a 0.13 M of amino acids. The corresponding increases of compressive strengths due to the same dosage of amino acid solution were in the range of 2% to 33%. The addition of 0.25 M amino acid solution increases the compressive and flexural strengths of the composites by 33% to 43% and 56% to 106%, respectively. The addition of 0.25 M L-serine was found to result in maximum strengths of the composites, i.e., 48% and 106% increases of the compressive and flexural strengths, respectively, compared to the control batch. Noteworthy, the L-aspartic acid containing batch showed more consistent compressive and flexural strengths with lower standard deviation which was attributed to the uniform spherical ACC formation in the matrix.

### SUMMARY

As observed in the Results section above, all the carbonated composite specimens prepared with amino acids were observed to form various mCaCO₃ phases, including vaterite, aragonite, and ACC. Based on the concepts of biomineralization, the interaction between amino acids and calcium carbonate crystals inhibits the transition from a mCaCO₃ to a stable polymorph (calcite). Thus, the Ostwald step sequence is stopped at one of its intermediate stages through the inhibition or stabilization of a particular metastable polymorphic phase (Zou, et al. (2017) Nano micro-Small 13(21): pages 1-11; L. Stajner, et al. (2018) Journal of Crystal Growth 486: pages 71-81). However, the effectiveness of the amino acids with respect to these processes was different, and it depended on their molecular characteristics. Specifically, L-aspartic acid was most effective in stabilizing the ACC polymorph of CaCO₃, followed by L-serine and finally L-arginine (FIG. 7C). It should be noted that L-Aspartic acid is negatively charged, L-arginine is positively charged, and L-serine is an uncharged amino acid. The higher efficiency of L-aspartic acid to inhibit the dissolution of ACC particles was presumably due to the negative charge of this amino acid. The negatively charged carboxyl surface sites of L-aspartic acid binds with Ca²⁺ sites of CaCO₃ by sharing an electron. Such a bond then inhibits further dissolution of ACC particles and the formation of stable polymorphs of CaCO₃ (second mechanism as discussed above) (Z. Zou, et al. (2017) Nano micro Small 13(21): pages 1-11). In the case of the L-serine specimens, only a partial inhibition of ACC and vaterite particle dissolution was observed in this study. The formation of calcite and vaterite in the presence of L-serine has also been reported in other biomimetic studies (Y. Guo, et al. (2013) Research on Chemical Intermediates 39: pages 2407-2415). In the case of L-arginine, the positively charged side chain can form a stable complex with HCO⁻₃ (Y. Guo, et al. (2013) Research on Chemical Intermediates 39: pages 2407-2415). This stable complex eventually leads to the formation of relatively smaller calcite and aragonite crystals, as observed with SEM and TGA (FIG. 2A-D). In addition to the above-discussed mechanisms, amino acids can form hydrogen bonds due to the presence of amine groups, which also inhibit the dissolution of mCaCO₃ (L. Stajner, et al. (2018) Journal of Crystal Growth 486: pages 71-81; Innocenti Malini, et al. (2017) Crystal Growth & Design 17(11): pages 5811-5822).

The addition of amino acids (and thus the formation of mCaCO3) resulted in higher strengths of the carbonated composites (FIGS. 11A and 11B), even though it increased the total porosity and decreased the degree of carbonation. Two hypotheses were proposed for such an increase in strength. First, during the stabilization process, the organic amino acids are adsorbed on the surface of these CaCO₃ polymorphs, which can lead to the formation of organic-inorganic hybrids/nanocomposites (FIG. 12). It is well known that such hybrid composites possess remarkable mechanical performance (B. Cantaert, et al. (2017) ChemPlusChem 82(1): pages 107-120). Specifically, previous studies (Y. Y. Kim, et al. (2016) Nature Materials 15: pages 903-910) showed that the presence of amino acids can increase the hardness of CaCO3 crystals by forming organic-inorganic nanocomposite phases. Consequently, the enhanced mechanical strengths, as observed in this study, can be attributed to such alternation of CaCO₃ intrinsic properties due to the presence of amino acids. Second, in addition to the intrinsic properties of CaCO₃ polymorphs, the reduction of critical pore size of the carbonated matrixes due to the addition of amino acids may have also enhanced the strengths of these matrixes.

Microscale Effects of Amino Acids

Effects of amino acids on carbonation reactions kinetics Calcite crystal formation and carbonation reaction can be controlled using different organic molecules. During the carbonation reaction, calcium silicate reacts with CO₂ in the presence of water and forms calcium carbonate and Ca-modified silica gel. This carbonation reaction leads to the formation of CaCO₃, which exists primarily in the form of crystalline calcite. The present study investigated the effects of amino acids on the wollastonite carbonation reaction rate and the impact of amino acids on CaCO₃ polymorphs.

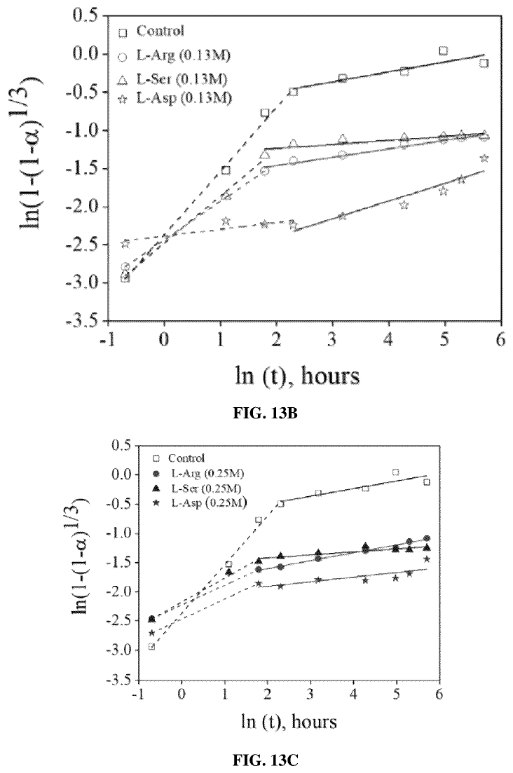

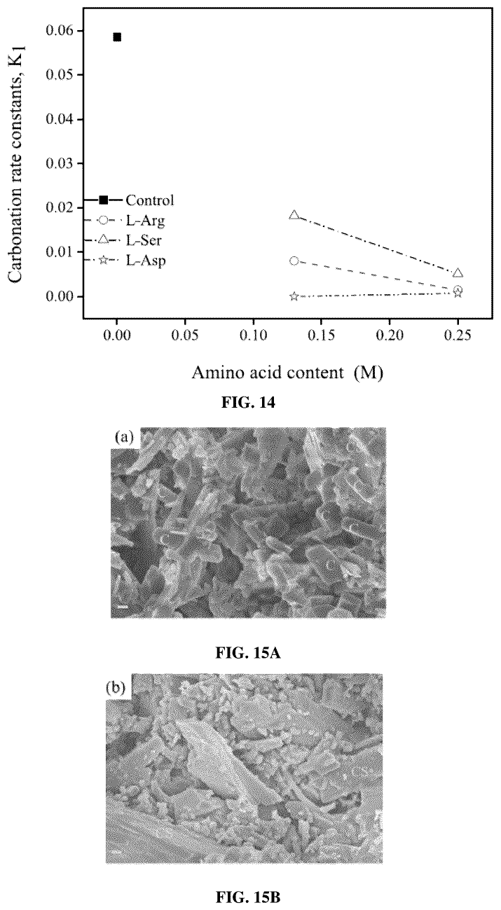

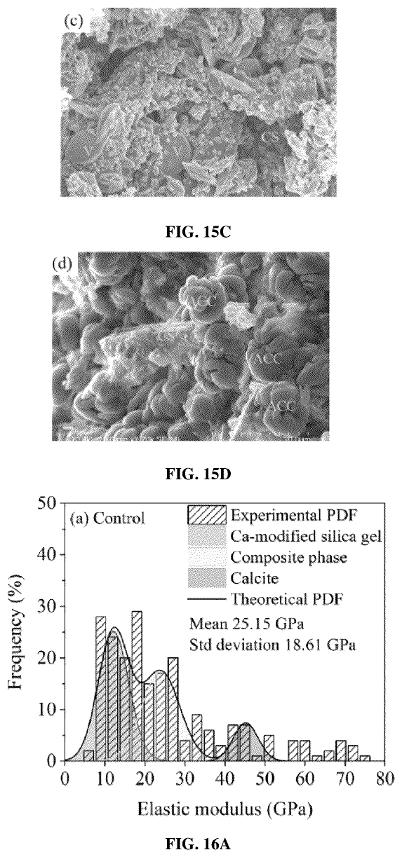

The amount of CaCO3 content (by weight %) formed during carbonation is calculated using Eqn. 1 and is shown in Table 5. The formation of CaCO3 was rapid initially (up to 10 h), and after that, there was a steadily growing stage (10 h to 300 h), as shown in FIG. 13A-13C. The quick dissolution of the calcium silicate phase could be the possible reason for this initial rapid carbonation reaction. Following this rapid carbonation, the carbonation rate reduced, and a slower reaction rate occurred. This slow reaction rate lasted until the end of the exposed carbonation period (300 h). Initial rapid carbonation and later slow reaction could also be referred to as ‘phase boundary control stage (stage 1)’ and ‘product layer diffusion stage (stage 2)’, respectively. The slower carbonation reaction rate after 10 h can be attributed to lower diffusion of CO₂ into binder matrix caused by the formation of a CaCO₃ layer.

TABLE 5
CaCO₃ content (% by weight) with carbonation duration

| Carbon- | | | | | | | |
|---|---|---|---|---|---|---|---|
| ation | | | | | | | |
| duration | | L-Arg | | L-Ser | | L-Asp | |
| (hours) | Control | 0.13 M | 0.25 M | 0.13 M | 0.25 M | 0.13 M | 0.25 M |
| 0.5 | 4.4 | 5.1 | 6.9 | 4.7 | 6.8 | 6.8 | 5.5 |
| 3 | 15.4 | 9.7 | 10.0 | 11.7 | 13.8 | 8.9 | 6.5 |
| 6 | 25.0 | 15.3 | 14.3 | 17.9 | 15.9 | 8.5 | 11.8 |
| 10 | 27.8 | 16.9 | 14.8 | 19.7 | 17.0 | 8.5 | 11.3 |
| 24 | 29.0 | 17.9 | 16.5 | 20.5 | 17.8 | 9.4 | 12.4 |
| 72 | 29.3 | 19.6 | 18.2 | 20.8 | 19.2 | 10.6 | 12.3 |
| 145 | 29.5 | 20.5 | 18.9 | 21.0 | 18.4 | 12.4 | 12.7 |
| 200 | 29.4 | 20.8 | 20.3 | 21.2 | 18.4 | 14.0 | 13.5 |
| 300 | 29.5 | 20.9 | 21.0 | 21.2 | 18.8 | 17.4 | 16.4 |

As observed in Table 5, the carbonation rate in the wollastonite batch without amino acids was higher than that of amino acids batches. Thus, the amino acids' addition retarded the carbonation reaction of wollastonite. After 300 h of carbonation, wollastonite without amino acid produced ˜30% CaCO3 (by weight), where 0.25 M concentration of L-Arg, L-Ser, and L-Asp acid mixed wollastonite produced 21%, 19%, and 16% CaCO3 by weight, respectively.

L-Arg, L-Ser, and L-Asp acid of 0.13 M concentration mixed with wollastonite produced 21%, 21%, and 17% of CaCO3 (by weight) after 300 h of carbonation period. Based on these findings, it was revealed that a higher amount of amino acids reduced the carbonation rate (Table 6).

TABLE 6
Reduction of CaCO3 amount (%) with respect to amino
acids addition

| Carbon- | | | | | | | |
|---|---|---|---|---|---|---|---|
| ation | | | | | | | |
| duration | | L-Arg | | L-Ser | | L-Asp | |
| (hours) | Control | 0.13 M | 0.25 M | 0.13 M | 0.25 M | 0.13 M | 0.25 M |
| 0.5 | 0.0 | 15.5 | 55.3 | 4.9 | 53.3 | 52.3 | 24.3 |
| 3 | 0.0 | −36.8 | −35.0 | −24.0 | −10.3 | −42.2 | −57.6 |
| 6 | 0.0 | −38.7 | −42.7 | −28.5 | −36.3 | −65.9 | −52.8 |
| 10 | 0.0 | −39.0 | −46.7 | −29.0 | −38.7 | −69.6 | −59.3 |
| 24 | 0.0 | −38.2 | −43.1 | −29.2 | −38.7 | −67.6 | −57.1 |
| 72 | 0.0 | −32.9 | −37.7 | −29.0 | −34.5 | −63.9 | −57.9 |
| 145 | 0.0 | −30.5 | −35.9 | −28.9 | −37.7 | −58.0 | −56.9 |
| 200 | 0.0 | −29.4 | −31.1 | −28.1 | −37.5 | −52.3 | −54.1 |
| 300 | 0.0 | −29.1 | −28.8 | −28.0 | −36.2 | −41.1 | −44.4 |

Eqn. 4 was plotted in FIGS. 13B and 13C. For both stages, a good agreement was observed for theoretical values predicted by the model. For the ideal case, the slope of the fitted curves should be 1 for stage-1 and 0.5 for stage-2. In this study, for the control batch, the slope of the stage-1 curve was 0.83, and the slope for stage-2 was 0.13, which was close to the value predicted by a previous stud.

The values of calculated reaction constants of stage-1 are shown in FIG. 14. The carbonation reaction rate was found to decrease with amino acids. Wollastonite without the addition of amino acid, has a higher carbonation rate, and wollastonite with the addition of L-Aspartic acid has the lowest carbonation rate.

The reduced amount of CaCO3 formation and carbonation reaction rates of wollastonite, as observed in FIG. 12 and FIG. 14, respectively, can be attributed to the formation of metastable CaCO3 (mCaCO3) in the matrix. As reported in earlier research, the addition of amino acids increases the amount of ACC in the carbonated matrix. Due to ACC's high solubility, the formation of this phase results in the solution becomes saturated with Ca2+ and carbonate ions, thereby avoiding the additional dissolution of calcium silicate and CO2 in the solution to react. Consequently, the carbonation rate has been reduced. Additionally, carboxylic groups (COOH—) of amino acid have an un-paired electron that can bond with the Ca2+ ion in wollastonite. Amino acids can be adsorbed on the wollastonite surface as a result of this interaction, which reduces the amount of surface area accessible for the reaction. Such a reduction in surface area is also attributed to a lower degree of carbonation. ACC is less denser than other polymorphs of CaCO3. Thus, the higher amount of ACC leads to fewer pores in the carbonated matrix, resulting in low carbonation. Among the amino acids used in this study, L-Asp acid-containing carbonated wollastonite was found to have higher amounts of ACC than other amino acids, which subsequently resulted in lower CaCO3 (by wt. %) formation in the composites (FIG. 13A). Furthermore, the interaction between the organic additives and the surface of CaCO3 particles can be considered to be governed by van der Waals force. In suspension, the long alkly chain of additives prefer to adsorb on the surface of CaCO3 rather than to hydrate with water retarding the dissolution. This interaction delays the phase transition of CaCO3 by balancing the hydration energy, lattice enthalpy, and the surface energy of CaCO3 particle.

Microstructural Change Due to Amino Acids

SEM images of carbonated composites after 145 h of carbonation are shown in FIG. 15A-D, confirming the formation of metastable CaCO3 in amino acid incorporated samples. Carbonation of the control batch formed calcite with a particle size greater than 2 μm (FIG. 15A)) In the case of L-Arg, it reduced the size of the rhombohedral calcite crystal, as shown in FIG. 15B. FIG. 15C shows the formation of plate shape vaterite in the case of L-Ser containing carbonated composites. L-Asp-containing carbonated composites formed a uniformly clustered amorphous CaCO3 (ACC) with a particle size of less than 500 nm (FIG. 15D).

The addition of L-Arg resulted in the reduction of crystal size. The amino acids had a regulation effect on the crystal morphology of CaCO₃. It should be noted that along with the amino group, the carboxyl group in amino acids also plays an important role in controlling the morphology of CaCO₃. The limited growth of CaCO₃ can be due to the coordination of Ca²⁺ (from the partial dissolution of CaCO₃) with oxy-gen atoms of carboxyl group and nitrogen atoms. Due to this, the samples containing amino acids displayed smaller particle size than the control sample.

Nanomechanical Properties

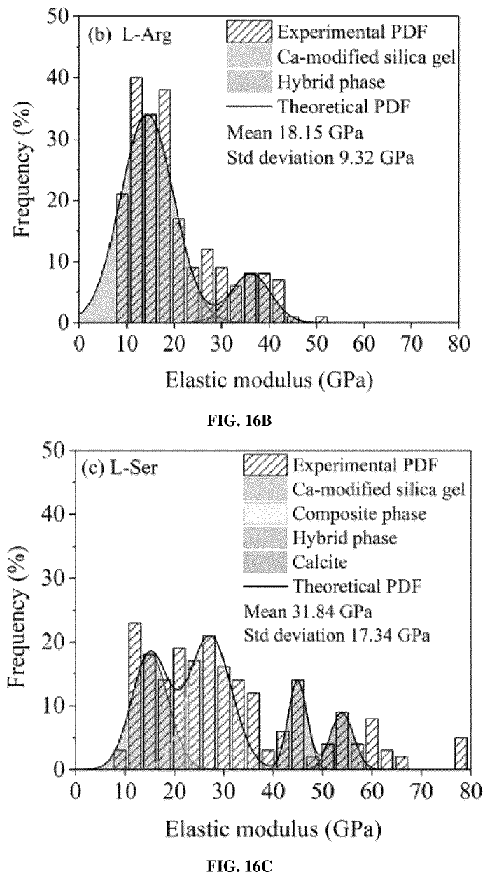

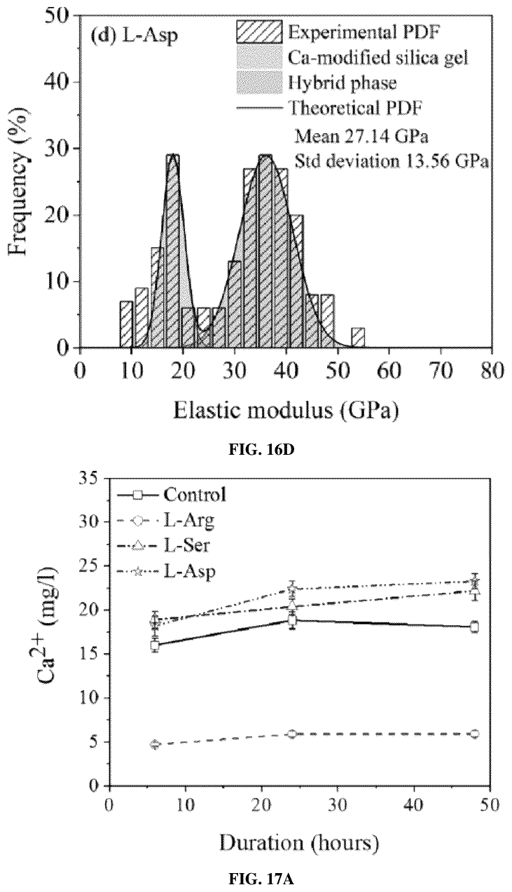

The disc samples were used to perform nanoindentation over two different 60 μm×60 μm areas in a grid pattern. A total of 220 indentations were performed per paste sample. FIG. 16 shows the frequency distribution of the 145 h carbonated samples. The SNI (statistical nanoindentation) method was used to determine the mean elastic modulus of microstructural phases (i.e., Ca-modified silica gel, com-posite phase, hybrid phase, and calcite phase). In the control sample, it was observed that the Ca-modified silica gel, composite phase, and the calcite had mean elastic modulus of 12.2 GPa, 23.9 GPa and 45.2 GPa, which is similar to the previous studies. The elastic modulus of the unreacted phases (more than 60 GPa) was not taken into consideration. The composite phases included the Ca-modified silica gel with the calcium carbonate polymorphs. A previous study showed that the mean elastic modulus of pure metastable calcium carbonate (aragonite, vaterite) are in the range of 15-35 GPa. Therefore, the formation of vaterite in amino acid containing batches was expected to reduce the elastic modulus compared to the control batch (containing calcite). Contradictorily, an amino acid containing batches, especially L-Asp and L-Ser batches, showed higher mean modulus compared to that of the control batch. Specifically, in the case of L-Asp containing batch, a significantly higher amount of phase with modulus ranging from 30 to 50 GPa was observed (FIG. 16D). While not being bound by theory, the results suggest that this increase in the elastic modulus in amino acid containing batch compared to the pure vaterite (15˜35 GPa) or calcite (control batch, ˜45 GPa) is due to the formation of organic-inorganic hybrid phase. Worthy to note, the formation of such organic (amino acids)-inorganic (calcium carbonate) is one of the primary mechanisms of stabilizing typical metastable CaCO3 (i.e., vaterite, ACC) during the biomineralization process. The formation of such organic-inorganic hybrid phase was attributed to the increased flexural strength (106% higher compared to the control) of the carbonated wollastonite composites. Findings from this work confirm that the enhancement of the mechanical properties of the carbonated wollastonite composite due to the addition of amino acids is valid at the microscale too.

Macroscale Effects of Amino Acids

Effects of Amino Acids on the Ion Leaching and Polymorphic Change of Carbonated Matrixes

This experiment aimed to understand how amino acids stabilized polymorphs of CaCO3; and affected the leaching of ions from the carbonated matrixes. The higher amount of Ca2+ leaching indicates the dissolution of the binding phases (here CaCO3 and Ca-modified silica gel) and increases the porosity of the matrix. Hence, it could eventually reduce the strength of the matrix. The amount of calcium ion diffusion depends on the chemical bond of calcium to other minerals in the solid matrix.

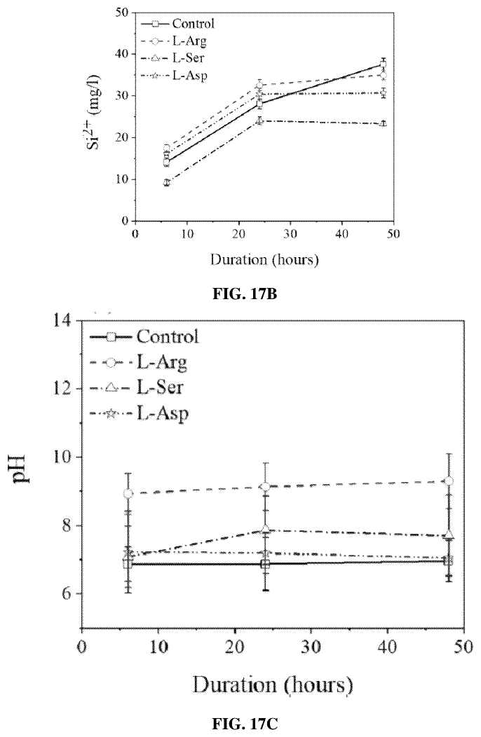

FIG. 17A represents the amounts of Ca²⁺ leached out from the carbonated wollastonite matrixes with time. The lowest amount of Ca²⁺ leaching was observed for the matrix containing L-Arg. On the other hand, carbonated wollastonite with L-Asp showed the highest leaching rate of Ca²⁺ ions. The leaching rate of Ca²⁺ ions from carbonated wollastonite was below 20 mg per liter for L-Arg, L-Ser, and control batches after 48 h. On the other hand, L-Asp leached 24 mg of Ca²⁺ per liter of water after 48 h of soaking, indicating a relatively higher rate of CaCO₃ dissolution in this matrix. Carbonated wollastonite combined with L-Arg leached more Si²⁺, and L-Ser leached less Si2+ over time, as shown in FIG. 17B. For all batches, Si²⁺ leaching was less than 40 mg/l. Further study needs to be conducted to understand better this leaching behavior of amino acids containing carbonated composites.

FIG. 17C indicates the pH variability over time of various amino acids combined with wollastonite. Among all amino acids combined with wollastonite batches, L-Arg has the highest pH, and L-Asp has the lowest pH. Higher pH in pore solution reduces the leaching of ions. Due to the higher pH in L-Arg containing carbonated matrix, Ca²⁺ ion leaching was low. According to Luo et al., calcium aspartate could be formed in the presence of L-Asp, which lowers the pH by reducing the ion con-centration. Traditional hydrated OPC-based concrete has a pH at around 13. Higher pH is needed to create a passivation layer that helps prevent the reinforcement's corrosion under the concrete. Lower pH breaks through the passivation layer and initiates corrosion. A pH of more than 9.4 is required for the stabilization of the passivation layer on reinforcement in concrete. However, the pH of the carbonated matrixes are expected to be lower because of the absence of Ca(OH)₂ and other alkali hydroxides in this system. Thus, in general, reinforcement in carbonated matrixes is more prone to corrosion compared to the traditional Portland cement. Having a higher pH of 9.3, as in the case of L-Arg batch, is a promising indication that after adequate modification of CaCO₃ polymorphs, it may be possible to maintain a high pH in the carbonated matrix and thus, lowering the corrosion potential in this system.

The soaked samples were kept in the vacuum desiccator for 24 h for drying. The dried samples were ground using a mortar and pestle. The TGA and FTIR tests of ground samples were performed to check any alternation of CaCO₃ polymorphs due to soaking at 60° C.

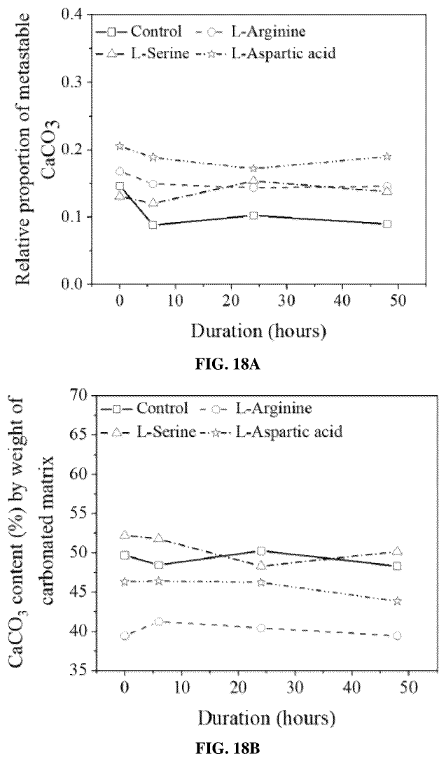

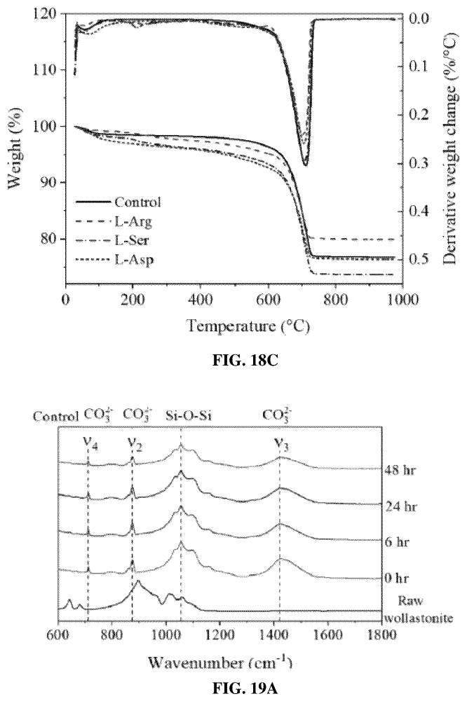

TGA results of the ground samples stored in the vacuum chamber after soaking in deionized water are shown in FIG. 18A-18B. The calculation procedure for the relative proportion of metastable CaCO₃ and CaCO₃ content (%) is discussed herein. Carbonated wollastonite with L-Asp acid has a higher amount of mCaCO₃ (FIG. 18A), and CaCO₃ without amino acid has less amount of mCaCO₃. It was also revealed that there was no significant change in the metastable CaCO₃ regardless of leaching. It can be inferred that there was no morphological change due to leaching. There was no significant change in the content of CaCO3 (% by weight), as shown in FIG. 18B, after soaking in deionized water.

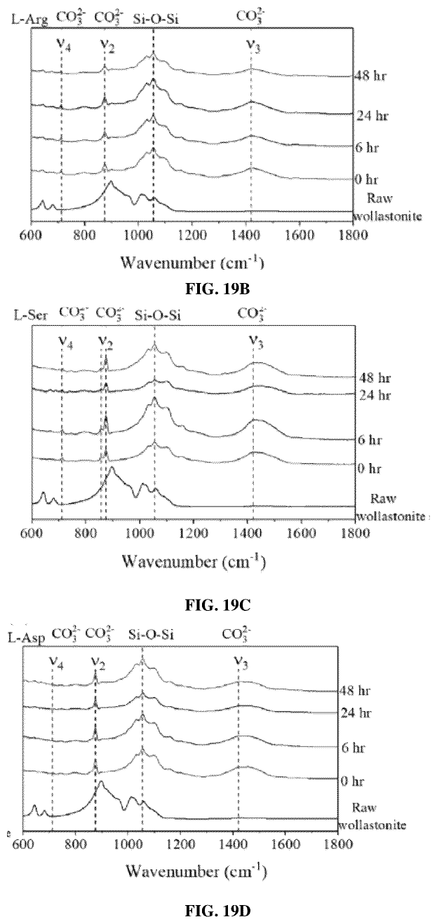

The FTIR spectra of carbonated wollastonite before and after moisture exposure are shown in FIG. 19A-D. CaCO3 polymorphs can be identified from the distinct peaks of FTIR spectra. Doubly generated planner bending vibration v4 at frequencies 712 cm⁻¹ and out of plane bending v2 at frequencies 872 cm⁻¹ are typical calcite peaks. This acute calcite peak v4 was observed in the control batch, and L-Arg, L-Ser containing carbonated wollastonite batches. This peak was not present in L-Asp-containing wollastonite batch, indicating the absence of calcite in the sample (FIG. 19D). The v2 peak at wavenumber 872 cm⁻¹ was observed in all the batches. The v2 bending vibration at 856⁻¹ is the characteristic aragonite peak. This peak was apparent for the batch-containing L-Ser (FIG. 19C), indicating mCaCO3 in this batch. Sharp antisymmetric stretching v3 at about 1420 cm⁻¹ is the distinctive peak for calcite, and a broad antisymmetric stretching v3 around this wave-number is the characteristic peak for ACC. The control batch has a sharp peak at this wavenumber, indicating the formation of calcite (FIG. 19A). In the case of amino acid-containing batches, this v3 stretching peak was broad, indicating the formation of ACC. Asymmetrical stretching vibration at approximately 1100 cm⁻¹ and 1200 cm⁻¹ wavenumbers showed the formation of silica gel polymerization.

The mCaCO₃ phases formed at the early stages are known to instantaneously convert to calcite via solid-state conversion when exposed to water. Accordingly, the moisture exposure experiment was performed in this study to investigate the stability of mCaCO₃ formed in the carbonated wollastonite composites due to the presence of amino acids. As observed in FIG. 19, there were no significant changes in the CaCO₃ polymorphs present in the carbonated composites due to the moisture exposure. As shown in FIG. 19B, no change in CaCO₃ polymorphism was observed except for a decrease in calcite peak intensity at 712 cm⁻¹ (v4 vibration) for L-Arg containing carbonated wollastonite. FIGS. 19C and 19D presented the results of carbonated wollastonite with L-Ser and L-Asp, respectively. There were no changes in CaCO3 poly-morphs due to the leaching of ions in both cases. This also supports the TGA results shown in FIG. 18B. Hence, overall, it could be concluded that the metastable CaCO₃ that is stabilized using amino acids remains stable after exposure to water for a longer duration (in this study, 48 h). The amino acid containing carbonated samples can be stored in the lab (25° C.) condition for two years without any changes in morphology.

Fracture Toughness

Th data herein revealed the impact of amino acids on the compressive and flexural strengths of carbonated composites. According to the investigation results, carbonated wollastonite's flexural and compressive strengths increased by 106% and 48%, respectively, as their amino acid concentration increased. Notably, the batch containing L-Asp exhibited more consistent compressive and flexural strengths with a reduced standard deviation, which was attributable to the production of consistent spherical ACC in the matrix. In the current study, the fracture toughness of the amino acids containing carbonated wollastonite composites was also investigated.

Fracture toughness is a cracking resistance capability used to analyze the fracture behavior of quasi-brittle materials. To determine Mode I fracture toughness, a three-point bending test with a notched beam specimen was performed. The addition of amino acids reduces the critical pore size (maximum intensity pore size) in the carbonated wollastonite matrix, as reported in. According to Hu et al. (Constr. Build. Mater. 70 (2014) 332-338), pore size distribution influences the cement paste matrix's strength, permeability, volume change, and toughness. Therefore, the addition of amino acids improves the carbonated system's mechanical performance and toughness.

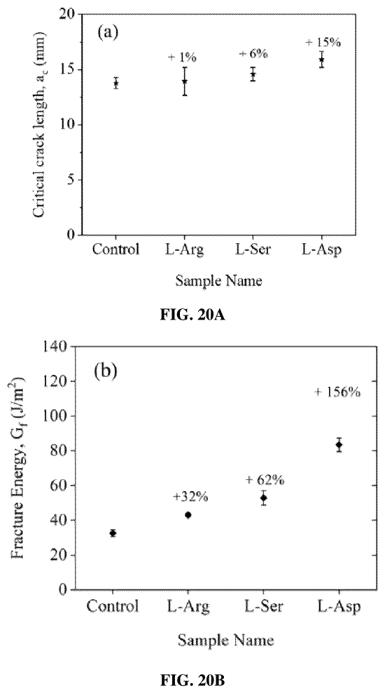

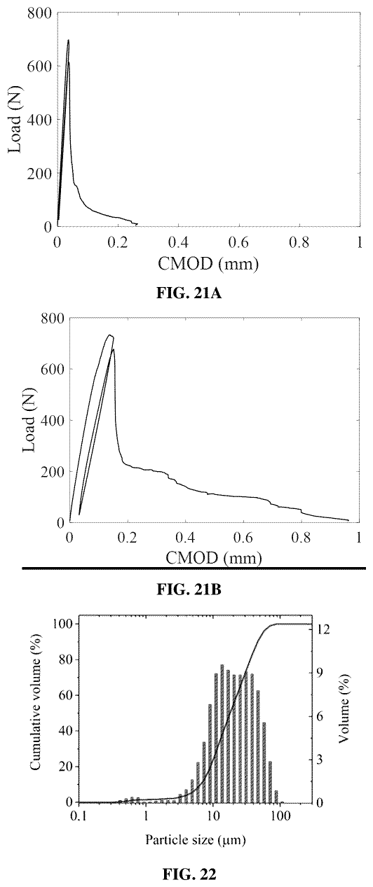

FIG. 20A shows the results of effective critical crack length, ac. Here all materials have almost similar ac which indicates that all materials have the same crack initiation energy. The higher amount of metastable CaCO₃ (mCaCO₃), amino acid-containing carbonated wollastonite has higher fracture energy (GO than the control batch. The fracture toughness of carbonated wollastonite containing L-Arg, L-Ser, and L-Asp acids is 32%, 48%, and 156% higher than the control batch. Three to four sample sets were carbonated and analyzed to validate and diminish the uncertainty of the results. Higher fracture energy represents the higher energy required to propagate the crack. The toughness of a composite material also depends on the material characteristic ahead of the crack tip, the degree of crystallinity, and the crystal size of the matrix. Additionally, Deshmane et al. postulated that higher crystallinity reduces the toughness of CaCO₃ matrix. Accordingly, the higher fracture energy of L-Aspartic containing batch could be due to the presence of lower crystalline CaCO₃ in the composite. FIGS. 20a and 20B show that amino acid-containing wollastonite batches exhibit higher ductility than the control batch, as demonstrated by the higher maximum CMOD.

### 4. Conclusions

Following is the list of major observations from this study.

The addition of amino acids resulted in the stabilization of typical mCaCO₃, namely ACC, vaterite, and aragonite, in carbonated wollastonite composites.

L-Aspartic acid was most effective in stabilizing the ACC in the carbonated composites. L-Serine resulted in the stabilization of both ACC and vaterite. The effectiveness of L-arginine was more prominent in reducing the CaCO₃ carbonate crystal size, but not in altering the polymorphs.

The formation and stabilization of mCaCO₃ resulted in a lower degree of carbonation of wollastonite under similar experimental conditions. Such a reduced degree of carbonation due to the addition of amino acids was attributed to their higher solubility, the adherence of amino acids to the surface of the wollastonite, and the different densities of the mCaCO₃ polymorphs.

The total porosity of the carbonated composite was increased due to the addition of amino acids. However, amino acids decreased the critical pore diameter compared to the control batch.

The carbonated composites containing amino acids showed up to 48% and 106% increase in compressive and flexural strengths, respectively, compared to the control batch.

The studies herein present a bio-inspired approach to control the CaCO₃ crystallization in carbonated cementitious systems using amino acids. The following concluding remarks can be made from this study:

The carbonation rate decreased with amino acid addition in the carbonated wollastonite matrix. Moreover, the higher dosage of amino acids resulted in a slower carbonation rate.

It was demonstrated through SEM images that metastable forms of CaCO3 were obtained with the addition of amino acids. The observed phases were dependent on the alkyl chain length of amino acids.

Nanoindentations revealed that the mean moduli of the carbonated composite containing L-Asp and L-Ser were higher than the control batch. Such enhanced nano-scale elastic modulus was attributed due to the organic-inorganic hybrid phase formation in the presence of amino acids.

The leaching of Ca²⁺ ions from the carbonated matrix was increased due to the amino acids addition. However, the effects of such leaching on the total amount of CaCO3 and its polymorphs were not noticeable.

No polymorphic change of CaCO³ was noticed after moisture expo-sure, which indicates the higher durability of this organic-inorganic hybrid system.

Amino acids increased the pH of the carbonated matrix. L-Arg with carbonated wollastonite has a pH of 9.3. Therefore, adding selected amino acids can be useful in stabilizing the passivation layer on the reinforcements present in carbonated concrete, thus making these reinforcements less vulnerable to corrosion.

L-Asp acid-containing carbonated calcium silicate has 156% higher fracture energy than the control batch. This increased toughness was attributed to the potential formation of organic-inorganic hybrid phases as those generally found in biomineral.

In summary, this study provided experimental evidence that amino acids can be a potential chemical admixture to enhance the mechanical performance of carbonated calcium silicate composites. Nevertheless, additional studies are required to understand the mechanism of performance enhancement of these composites in the presence of amino acids. Such an understanding will allow us to develop non-natural, affordable, and sustainable amino acid-mimics to achieve similar benefits in industrial scale production of carbonated cement composites.

### II. Utilization of L-Aspartic Acid and L-Glutamic Acid to Enhance the Properties of Carbonation Cured Gamma Dicalcium Silicates (g-C₂S)

This study investigated the effectiveness of different biomimetic molecules to enhance the properties of carbonation in gamma dicalcium silicate (g-C₂S) based cementitious system. Low dosages (2.5% and 5%) of L-aspartic acid (LAsp) and L-glutamic acid (LGlu) were added to the g-C₂S paste during mixing. Thermogravimetric analysis (TGA) showed that the CaCO₃ content was the highest in 5% LGlu based system. LGlu containing batch formed vaterite reducing the calcite contents. The biomimetic molecules modified batches exhibited the higher compressive and flexural strength properties. 5% LAsp modified batch showed 52% higher compressive strength and 54% higher flexural strength than the control batch. Nevertheless, 5% LGlu also exhibited higher flexural strength, 53% higher than the control batch.

Dicalcium silicate (C₂S) can potentially lower the energy needed for cement manufacturing by 0.29 to 0.42 GJ/tonne of clinker when used as the major cement compound (for example, belite-based binders) Click or tap here to enter text. Even though Portland cement largely comprises b-C₂S, in recent studies, g-C₂S has received attention for several reasons. First, g-C₂S is less active than b-C₂S Click or tap here to enter text. If an activation method is identified to be effective for g-C₂S, it is expected to be equally or more effective for b-C₂S activation. Second, even though both g-C₂S and b-C₂S have lower production temperature requirements, b-C₂S often requires more energy to grind than C₃S. L-aspartic acid (LAsp), L-glutamic acid (LGlu) were chosen to observe their ability to enhance the nano and micro-structural properties of carbonated γ-C₂S composites. The hypothesis is these biomimetic molecules can alter the CaCO3 polymorphs formation which will eventually enhance the micro and nano-mechanical performance of the carbonated γ-C₂S composites. For this, micro-structural analysis and mechanical performance were checked on carbonated γ-C₂S composites to verify the hypothesis.

### 1. Materials and Methods

### 2.1 Raw Materials

There are several methods for synthesizing pure calcium silicate phases. Most of these methods use the technique of sintering the stoichiometric mixture of lime and silica. In this study, CaCO3 (>99% purity) and fumed silica (>99% purity) were used to synthesize g-C₂S. As mentioned earlier, L-aspartic acid (C₄H₇NO₄; MW 133.10 and high purity grade), and L-glutamic acid (C₅H₉NO₄; MW 147.13) were used as the biomimetic molecules. All these raw materials and biomimetic molecules were purchased through VWR.

### 2.2 Sample Preparation

Uniform mixing of CaCO3 and fumed silica was prepared to obtain a molar ratio of 2:1 in the presence of water (w/b was maintained 0.65 to ease the mixing procedure). This paste mixture was then placed inside a high temperature furnace and sintered up to 1400° C. for 4 h. After this, it was left inside the furnace until it cooled down to a room temperature following a slow cooling process to ensure the stabilization of g-C₂S. The resulting products were ground, sieved through mesh #200 (74 mm) and fried twice to maximize the chemical reaction of available lime and silica. From thermogravimetric analysis (TGA), it was checked that the free lime content of the synthesized g-C₂S was maintained to be below 3%. The particle size distribution of the synthesized g-C₂S is shown in FIG. 22 which was determined using a commercially available laser particle size analyzer.

Two types of samples were prepared for carbonation curing: (i) thin disc from paste samples (˜5 mm thick and 20 mm dia) and (ii) compacted paste cube and beam samples. First type of samples was used to monitor the CaCO3 polymorph formation and evolution along with nanomechanical properties during the carbonation period. The second category was prepared for mechanical strength and pore size distribution analysis. For preparing the paste samples, dry biomimetic molecules were first mixed with water at 2.5% and 5% concentration (by weight percentage of g-C₂S). The control batch contained no biomimetic molecules. g-C₂S powder was then mixed using a high shear mixer (at 350 rpm for 2 min). The water to binder (w/b) ratio was maintained as 0.40 throughout the experimental process. Then the samples were put inside a commercially available carbonation chamber setting the relative humidity at 80%, CO₂ concentration at 20% and room temperature (27° C.). FIG. 23 shows the schematic diagram of the sample preparation of each experiment.

### 2. Test Methods

### 3.1 Thermogravimetric Analysis (TGA)

A commercially available instrument (TA instrument, TGA 550) was used for the TGA experiment of paste sample. The paste samples preserved in a vacuum desiccator as mentioned in the previous section were used for this test. The collected samples were ground using a mortar pestle to obtain a fine powder. Approximately 25˜30 mg of #200 sieve passing powdered sample was loaded into the platinum pan and kept under isothermal condition for 5 minutes at 25° C. The temperature of the chamber was then raised until 980° C. with an increment of 15° C. per minute. Nitrogen gas was purged to ensure an inert environment. Initially, for a few batches, three replicate samples were tested through TGA to validate for any deviation in carbonation across samples. The test result deviations were less than 2% by weight of total carbonated samples. Due to the low deviation, TGA was performed only with one sample for the remainder of the batches.

### 3.2 Compressive and Flexural Strength Testing

The compressive and flexural strength of 25 mm×25 mm×25 mm cube and 40 mm×20 mm×15 mm beam paste samples were measured after 7 days of carbonation curing. The compressive strength was measured via Gilson compressive strength teasing machine using a loading rate of 450 N/s. The 3-point bending test (flexural strength) was measured by a laboratory made micro-mechanical tester using a displacement rate of 1 mm/min.

### 3. Results

### 4.1 Effects on the Carbonation Extent and CO₂ Sequestration

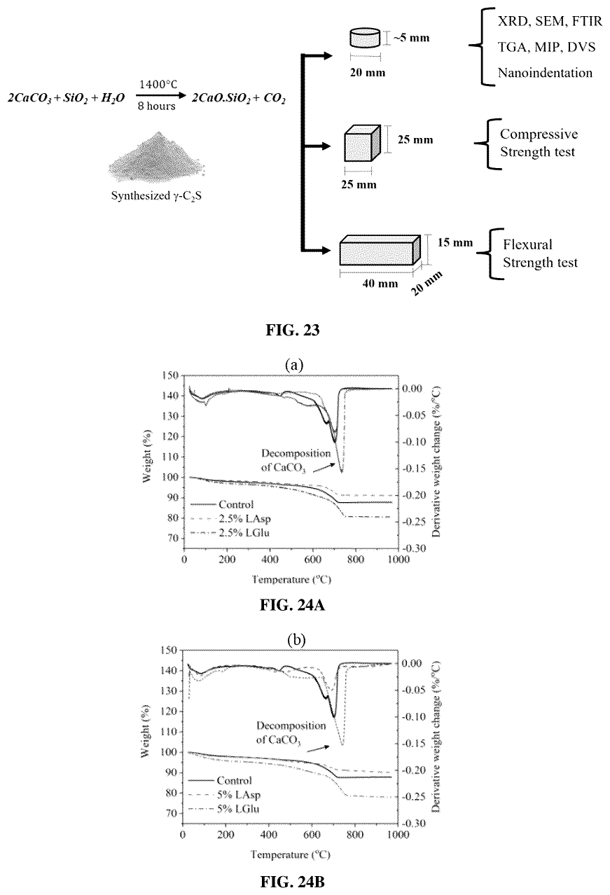

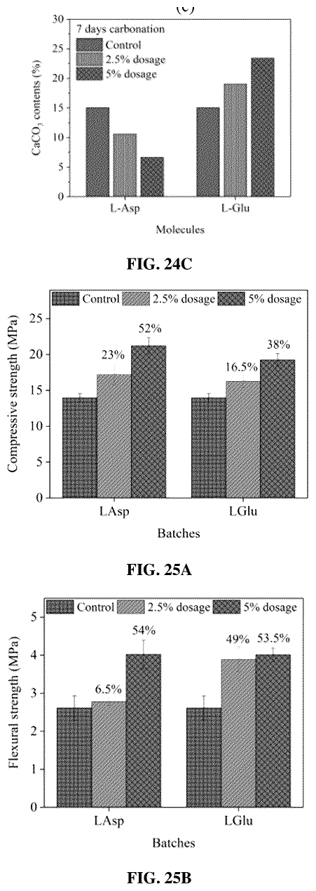

The thermogravimetric analysis graphs (TGA and DTG) of 7 days carbonated samples are shown in FIG. 24A-C. Mass losses in the temperature range of 500-800° C. of 7 days cured paste samples were due to the decomposition of CaCO3 phases Click or tap here to enter text. Presence of multiple DTG peaks in this temperature range were attributed to the decomposition of different polymorphs of CaCO₃. From, SEM and XRD analysis, multiple CaCO₃ polymorphs formation was also confirmed. TGA results were eventually used to calculate the total CaCO₃ contents decomposed in the system FIG. 24C.

It was observed that with the increase of the dosage in LAsp batches, the CaCO₃ contents got decreased. This observation matches with previous findings on the role of LAsp in carbonated wollastonite composites. For LGlu batches, the observation was opposite to that of LAsp. Increasing the dosage of LGlu increased carbonate formation, and therefore, the degree of carbonation. The CO₂ stored in the carbonated composite increased by nearly 46% due to the addition of 5% LGlu.

### 4.2 Effects on Compressive and Flexural Strengths

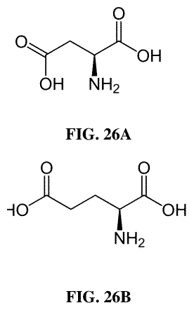

FIGS. 25A and 25B are exhibits of the compressive and flexural strength properties of the 7 days carbonated g-C₂S paste samples with and without the addition of biomimetic molecules. FIG. 25A shows that 5% LAsp modified g-C₂S paste samples resulted in 52% higher than the control batch, respectively.

FIG. 25B shows the flexural strength properties of the 7 days carbonated paste samples. Both 2.5% and 5% dosage increased the flexural strength in the carbonated cementitious system. The flexural strength of the beam samples increased by 54% by the addition of 5% LGlu and 5% LAsp. Even though LAsp modified batch did not show significant CaCO3 polymorphs formation in the microstructure, it enhanced the strength properties because of the adhesion characteristics of aspartic acid Click or tap here to enter text.

### 4. Discussion

This study showed that the selected biomimetic molecules can affect the amounts and polymorphs of the carbonates form in the carbonated g-C₂S composites. With the increasing amounts of LAsp, an increase in the mechanical performance was observed, even though the degree of carbonation was reduced. The negatively charged LAsp forms complex phases with Ca²⁺ surface sites of CaCO₃ and subsequently, stabilizes typical metastable polymorphs of CaCO₃, including vaterite and ACC, which cause the strength enhancement due to the addition of this molecule. Increased dosage of LGlu enhanced the mechanical performance as well as the degree of carbonation of the composites, and therefore making LGlu a more effective admixture for g-C₂S compared to the LAsp. Such differences in the roles of LAsp and LGlu could be due to their different chain length and solubility (see FIGS. 26A and 26B). The solubilities of LGlu and LAsp are 8.6 g/L and 4.5 g/L in water at room temperature. A higher solubility limit is likely to make LGlu more effective in controlling the carbonate polymorphs.

### CONCLUSION

The following are the concluding remarks from the present study:
i. TGA results showed that L-Glu formed higher amount of calcium carbonate formation compared to the control batch. Addition of biomimetic molecule accelerated the degree of reaction.
ii. All the batches showed lower nano-porosity compared to the control batch which resulted in higher compressive strength. Among the batches, 5% LAsp batches showed an increase of compressive strength by around 52%.

5% LGlu produced the highest amount of calcium carbonate contents.

### REFERENCES

Ren, Q. Feng, X. Bourrat, Effects of additives and templates on calcium carbonate mineralization in vitro, Micron. 42 (2011) 228-245, https://doi.org/5
Gebauer, A. V\ddot{ } olkel, H. C\ddot{ } olfen, Stable prenucleation calcium carbonate clusters, Science (80-.) 322 (2008) 1819-1822
\check{ } Sev\check{ } cik, P. et al. J. Mater. Sci. 53 (2018)
Addadi, S. Raz, S. Weiner, Taking advantage of disorder: amorphous calcium carbonate and its roles in biomineralization, Adv. Mater. 15 (2003) 959-970,
Ashraf et al. J. CO2 Util. 23 (2018) 61-74
Ashraf, et al, Carbonation reaction kinetics, CO2 sequestrationcapacity, and microstructure of hydraulic and non-hydraulic cementitious binders, Sustainable Construction Materials and Technologies. 2016-Augus (2016).
Ashraf, et al, Cem. Concr. Compos. 72 (2016) 284-298,
Ashraf, et al. J. Mater. Sci. 51 (2016) 6173-6191,
Ashraf, et al., Cem. Concr. Compos. 93 (2018) 85-98.
Ashraf, et al., Appl. Clay Sci. 230 (2022),
https://doi.org/10.1016/j.clay.2022.106696.
Ashraf, et al. Cem. Concr. Res. 100 (2017) 361-372
Ashraf, et al., J. Mater. Sci. (2016), https://doi.org/10.1007/s10853-016-9909-4.
Ashraf, et al., Constr. Build. Mater. 210 (2019) 473-482,
Ashraf, J. Olek, V. Atakan, Carbonation reaction kinetics, CO2 sequestration capacity, and microstructure of hydraulic and non-hydraulic cementitious binders, in: Sustain. Constr. Mater. Technol, 2016.
Assessment. Trends in global CO2 and total greenhouse gas 2020 report, 2020 https://www.pbl.nl/en/publications/trends-in-global-co2-and-total-greenhousegas-emissions-2020-report #:˜:text=Trends %20 in %20Global %20CO2%20 and %20Total %20Greenho use %20Gas %20Emissions %3B %202020%20Report,-21% b22384.
Bernal, et al., Cem. Concr. Res. 53 (2013) 127-144,
Bernal, et al., Cem. Concr. Res. 42 (2012) 1317-1326,
Bernal, et al., Cem. Concr. Res. 57 (2014) 33-43,
Bukowski, et al., Cem. Concr. Res. 9 (1979) 57-68.
Burgos-Cara, et al., Minerals. 7 (2017) 1-15
Cantaert, et al., Chempluschem. 82 (2017) 107-120
Carpinteri, et al., Theor. Appl. Fract. Mech. 91 (2017) 66-75
Chakoumakos, et al. Sci. Rep. 6 (2016) 1-9,
Chakrabarty et al., J. Mater. Chem. 9 (1999) 2953-2957,
Chan, et al., Polypropylene/calcium carbonate
Chuajiw, et al. J. Cryst. Growth 386 (2014) 119-127
De Silva et al., Cem. Concr. Compos. 28 (2006) 613-620,
De Silva, et al., Cem. Concr. Compos. 28 (2006) 613-620,
Demidenko, et al, (A REVIEW), 58 (2001) 308-311.
Deshmane et al., Mater. Sci. Eng. A 452-453 (2007) 592-601
Dhami, et al., Ecol. Eng. 94 (2016) 443-454,
EIA, The Cement Industry Is the Most Energy Intensive of All Manufacturing Industries, 2013.
Flemming et al., Acta Chem. Scand. 45 (10) (1991) 1018-1024.
Gaitero, et al., Cem. Concr. Res. 38 (2008) 1112-1118, https://doi.org/10.1016/j.cemconres.2008.03.021.
Galan, et al., Environ. Sci. Technol. 44 (8) (2010) 3181-3186, https://doi.org/10.1021/es903581d.
Gallagher, FTIR analysis of protein structure, Nature. 18 (1958) 662-666.
Gao, et al, Materials and Structures/Materiaux et, Constructions 49 (2016) 3423-3434, https://doi.org/10.1617/s11527-015-0729-9.
Garc′es, et al. Corros. Sci. 53 (2011) 3991-4000
Go\tilde{ } ni, M. T. Gazta\tilde{ } naga, A. Guerrero, Role of cement type on carbonation attack, J. Mater. Res. 17 (2002) 1834-1842, https://doi.org/10.1557/JMR.2002.0271.
Golewski, Effect of curing time on the fracture toughness of fly ash concretecomposites, Compos. Struct. 185 (2018) 105-112, https://doi.org/10.1016/j. compstruct.2017.10.090.
Goto, K. Suenaga, T. Kado, Calcium silicate carbonation products, J. Am. Ceram. Soc. 78 (1995) 2867-2872.
Groves, A. Brough, I. G. Richardson, C. M. Dobson, Progressive changes in the structure of hardened C3S cement pastes due to carbonation, J. Am. Ceram. Soc. 74 (1991) 2891-2896, https://doi.org/10.1111/j.1151-2916.1991.tb06859.x.
Guo, et al. Res. Chem. Intermed. 39 (2013) 2407-2415
Hague, et al., Cem. Concr. Compos. 125 (2022),
He, et al, Effect of wollastonite microfibers as cement replacement on the properties of cementitious composites: A review, conbuildmat.2020.119920.
Hicks, M. A. Caldarone, E. Bescher, Opportunities from Alternative Cementitious Materials, Concr. Int. 37 (2015) 47-51.
Hu, et al., Constr. Build. Mater. 70 (2014) 332-338
Huet, L. Hostis, H. Idrissi, Electrochemical behavior of mild steel in concrete: Influence of pH and carbonate content of concrete pore solution, 51 (2005) 172-180. https://doi.org/10.1016/j.electacta.2005.04.014.
Ihli, et al. Nat. Commun. 5 (2014) 3169
Innocenti et al., Cryst. Growth Des. 17 (11) (2017) 5811-5822
van Mier, Fracture Processes of Concrete (2017),
Jenq, et al., J. Eng. Mech. 111 (1985) 1227-1241
Jiang et al., Nat. Commun. 8 (15066) (2017) 1-13.
Jiang, et al., Sci. Adv. 4 (2018) 1-12.
Juenger, et al., Cem. Concr. Res. 41 (2011) 1232-1243,
Kasha, et al., Colloids Surf A Physicochem Eng Asp 482 (2015) 290-299, https://doi.org/10.1016/j.colsurfa.2015.05.043.
Kellermeier, et al. J. Am. Chem. Soc. 132 (50) (2010) 17859-17866,
Khan, et al, Cem.Concr. Compos. 134 (2022), https://doi.org/10.1016/j.
Khan, et al, Constr. Build. Mater. 218 (2019) 150-161
Khan, et al., Cem. Concr. Res. 147 (2021) 1-39.
Khan, S. Siddique, W. Ashraf, Effects of magnesia in semi-hydraulic and nonhydraulic calcium silicate binders during carbonation curing, Constr. Build. Mater. 338 (2022), https://doi.org/10.1016/j.conbuildmat.2022.127628.
Kim, et al. Tuning hardness in calcite by incorporation of amino acids, Nat. Mater. 15 (2016) 903-910.
Kotachi, et al., Cryst. Growth Des. 6 (7) (2006) 1636-1641.
Kumar, et al. J. Am. Ceram. Soc. 100 (2017) 3316-3328,
L\acute{ } opez-Arce, L. S. G\acute{ } omez-Villalba, S. Martinez-Ramirez, M. \acute{ } Alvarez de Buergo, R. Fort, Influence of relative humidity on the carbonation of calcium hydroxide nanoparticles and the formation of calcium carbonate polymorphs, Powder Technol. 205 (2011) 263-269, https://doi.org/10.1016/j.powtec.2010.09.026.
Laniesse, et al Cem. Concr. Res. 106 (2018) 65-76,
Li, et al., Resour. Conserv. Recycl. 178 (2022),
Luo et al. Crystal Growth and Design. 16 (2016) 728-736
Ma, et al., New J. Chem. 39 (2015) 5309-5315,
Macías-s\acute{ } anchez, et al., Sci. Rep. 7 (2017) 1-11,
Mao, et al., Eur. J. Inorg. Chem. (2013) 5958-5963.
Maruyama, et al., Mater. Lett. 65 (2011) 179-181,
Mech, Abstract Poro-Damage Approach Applied to Hydro-Fracture
Analysis of Concrete Show Re ferences© 2007 American Society of Civil Engineers, 9399 (2016) 9399. https://doi.org/10.1061/(ASCE)0733-9399(2000)126.
Mehta, Greening of the Concrete Industry for Sustainable Development, Concr. Int. 24 (2002) 23-28.
Meiron, et al. J. Bone Miner. Res. 26 (2011) 364-372
Mess, A. F. Sarofim, J. P. Longwell, Product Layer Diffusion during the Reaction of Calcium Oxide with Carbon Dioxide, 69 (1999) 999-1005. https://doi.org/10.1021/ef980266f.
Morandeau, et al. Chem. Mater. 27 (2015) 6625-6634,
Moreno, Et al., Corros. Sci. 46 (2004) 2681-2699.
nanocomposites, 43 (2002) 2981-2992.
Okada, et al. Silicate anion structure and dehydration processes of okenite, J. Ceram. Soc. Jpn. 102 (1190) (1994) 919-924.
Oliver, G. M. Pharr, An improved technique for determining hardness and elastic modulus using load and displacement sensing indentation experiments, J. Mater. Res. 7 (1992), https://doi.org/10.1557/jmr.1992.1564.
Olivier, J. Peters, Trends in Global CO2 and Total Greenhouse Gas Emissions 2018 Report 53, PBL Netherlands Environ. Assess. Agency, 2018.
Orme, et al., Nature 411 (2001) 775-779.
Plummer et al. Geochim. Cosmochim. Acta 46 (1982) 1011-1040
Plummer, E. Busenberg, The solubilities of calcite, aragonite and vaterite in CO2, Geochim. Cosmochim. Acta 46 (1982) 1011-1040
Qiao, et al., Alternate deposition of oriented calcite and amino acid layer on calcite substrates, J. Phys. Chem. B 112 (43) (2008) 13635-13640.
Rakhimova, et al, Cem. Concr. Compos. 57 (2014) 55-63.
Ransinchung, et al, J. Mater. Civ. Eng. 22 (2010) 305-313, https://doi.org/10.1061/(ASCE)MT.1943-5533.0000019.
Ren, et al., Micron. 42 (2011) 228-245
Rodriguez-navarro, C. Jimenez-lopez, A. Checa, J. M. G. Ruiz, Nanocrystalline structures in calcium carbonate biominerals, J. Nanophoton. (2008).
Saharay, Rodriguez-J. Phys. Chem. B 117 (12) (2013) 3328-3336.
Sangodkar, et al. J. Am. Chem. Soc. 137 (2015) 8096-8112
Sato, et al., -New Cryst. Struct. 129 (1969) 405-410.
Scrivener, R. Snellings, B. Lothenbach, A Practical Guide to Microstructural Analysis of Cementitious Materials, 2018. https://doi.org/10.1201/b19074.
Shah, et al., Materials and Structures: Mat\acute{ } eriaux et, Construction 23 (1990) 457-460,
Shao et al., Can. J. Civ. Eng. 33 (2006) 776-784,
Shen, et al., Renew. Sustain. Energy Rev. 34 (2014) 337-349,
Shi, et al., Cem. Concr. Res. 122 (2019) 227-250,
Shi, et al., Cem. Concr. Res. 122 (2019) 227-250.
Shtepenko, et al., Chem. Eng. J. 118 (2006) 107-118, https://doi.org/10.1016/j.cej.2006.02.005.
Sommerdijk, et al., Chem. Rev. 108 (11) (2008) 4499-4550.
Song, et al., Adv. Mater. Sci. Eng. (2014 (2014).).
Stajner, et al., J. Cryst. Growth 486 (2018) 71-81
Stempfle, et al., Int. J. Nanotechnol. 4 (2007) 712-729.
Sun, et al., Energy and Environmental, Science 1 (2008) 370-377.
Sun, J. R. Grace, C. J. Lim, E. J. Anthony, A discrete-pore-size-distribution-based gas-solid model and its application to the CaO+CO 2 reaction, 63 (2008) 57-70.
Svensson, A. Neumann, F. F. Menezes, C. Lempp, H. P\ddot{ } ollmann, Carbonation of natural wollastonite at non-ambient conditions relevant for CCS—the possible use as cementitious material in wellbores, Applied Sciences (Switzerland). 9 (2019), https://doi.org/10.3390/app9061259.
Tapas, et al Mitigation (2019) 1-7.
Teng, et al, Thermodynamics of calcite growth: baseline for understanding biomineral formation, Science (80-.) 282 (1998) 724-727, https://doi.org/10.1126/science.282.5389.724.
Tobler, et al. Science 10 (2014) 143-148,
Tong, et al., Biomaterials. 25 (2004) 3923-3929.
U.S. energy-related carbon dioxide emissions fell in 2019, mainly in electric generation—Today in Energy—U.S. Energy Information Administration (EIA), https://www.eia.gov/todayinenergy/detail.php?id=45836 (accessed Oct. 22, 2021).
Van Gerven, et al. Waste Manag. 27 (2007) 977-985
Wan et al. Biomaterials 25 (2003) 3923-3929,
Weir, et al., J. Res. Natl. Bur. Stand. Sect. A Phys. Chem. 65A (2012) 173-180.
Weiss, et al. BMC Biophys. 11 (2018) 1-15.
Yousuf, et al., J. Environ. Sci. Heal. Pt A Environ. Sci. Eng. Toxicol. 27 (1992) 1503-1519, Yu et al., J. Am. Ceram. Soc. 82 (1999) 742-748.
Zhang, et al. Resour. Conserv. Recycl. 174 (2021),
Zhao, et al., PCCP 15 (2013) 15185-15192
Zhu, et al., J. Phys. Chem. B 110 (16) (2006) 8302-8306
Zou, et al., Small 13 (2017) 1-11

We claim:

1. An amino acid supplemented binder composition comprising one or more amino acids.

2. The composition of claim 1, wherein the amino acid is a naturally occurring amino acid.

3. The composition of claim 1, wherein the amino acid is selected from the group consisting of Alanine (Ala), Arginine (Arg), Asparagine (Asn), Aspartic Acid (Asp), Cysteine (Cys), Glutamine (Gln), Glutamic Acid (Glu), Glycine (Gly), Histidine (His), Isoleucine (Ile), Leucine (Leu), Lysine (Lys), Methionine (Met), Phenylalanine (Phe), Proline (Pro), Serine (Ser), Threonine (Thr), Tryptophan (Trp), Tyrosine (Tyr), and Valine (Val).

4. The composition of claim 3, wherein the amino acid is a hydrophilic amino acid.

5. The composition of claim 1, wherein the amino acid is a positively charged amino acids.

6. The composition of claim 1, wherein the amino acid is a negatively charged amino acid.

7. The composition of claim 1, wherein the amino acid is a polar (but not charged) amino acid.

8. The composition of claim 1, wherein the amino acid is selected from the group consisting of Arg, Asp and Serine.

9. The composition of claim 1, wherein the binder is a hydraulic binder, a non-hydraulic or a semi hydraulic binder.

10. The composition of claim 9, wherein the binder is a non-hydraulic binder selected from the group consisting of wollastonite, Tricalcium silicate (C3S), β-dicalcium silicate (β-C2S), γ-dicalcium silicate (γ-C2S), tricalcium disilicate (C3S2) and monocalcium silicate (CS).

11. The composition of claim 9, wherein the semi-hydraulic binder is slag.

12. The composition of claim 1, in the form of a solid, such as a powder.

13. The composition of claim 1, wherein the amount of amino acid in the composition ranges from about 1-about 20 wt % (wt. of binder).

14. The composition of claim 1, wherein the amount of amino acid in the composition is from about 3 to about wt % (of binder).

15. The composition of claim 1 wherein 100 g of the composition comprises about 3 to about 8% of a 100 g of amino acid.

16. The binder material is supplemented with amino acids in effective amounts to increase one or more properties of resulting composites made therefrom, as set forth below, when formulated into a composite.

17. Carbonated composites made from the composition of claim 1, wherein the composites have one or more of the following characteristics when compared to compositions made from the same binder, not supplemented with the one or more amino acids: (a) reduction in the amount of calcite and fully polymerized silica gel, (b) increase in the proportions of mCaCO3 (metastable ACC, aragonite, and vaterite polymorphs), (c) reduction in the amounts of CaCO3 (% by wt of the carbonated sample) compared to the control batch after the same carbonation duration (d) increase in the amounts of unreacted calcium silicate mineral, (e) refined pore sizes (based on critical pore diameter), and (e) increase in the compressive and flexural strengths in carbonation-activated calcium silicate composite materials formed following incorporation of the amino acid in the calcium silicate material composition, when compared to carbonation-activated composites formed without amino acids.

18. The composite of claim 17, selected from the group consisting of bridge girders, beams, blocks, hardscape components such as pavers, edging blocks, stepping stones, etc.

19. A method of making carbonated composites comprising subjecting the composition of claim 1 to a carbonation process, wherein the one or more amino acids is effective amounts to confer to the resulting carbonated composite material has one of the following properties when compared to composite materials cured under the same conditions in the absence of the one or more amino acids: (a) reduced amount of calcite and fully polymerized silica gel, (b) increase in the proportions of mCaCO3 (metastable ACC, aragonite, and vaterite polymorphs), (c) reduced amounts of CaCO3 (% by wt of the carbonated sample) compared to the control batch after the same carbonation duration (d) increase in the amounts of unreacted calcium silicate mineral, (e) refined pore sizes (based on critical pore diameter), and (e) increase in the compressive and flexural strengths in carbonation-activated calcium silicate composite materials formed following incorporation of the amino acid in the calcium silicate material composition.

20. The method of claim 19 wherein the amino acid is added to the binder composition as a solution to a solid form of the silicate-containing cementitious material at a solution to solid ratio of about 0.1 to about 1, preferably, from about 0.25 to about, 0.5, for example, 0.3, 0.4, 0.41, 0.42, 0.43, 0.44, etc.
